(19) United States
(12) Patent Application Publication
(10) Pub. No.: US 2019/0258301 A1
(43) Pub. Date: Aug. 22, 2019

(54) Electronic Device with Linking Housing Pivotally Coupled Between Device Housings

(71) Applicant: Motorola Mobility LLC, Chicago, IL (US)

(72) Inventors: Poliana Feliconio Pereira, Sao Paulo (BR); Roger C Harmon, Crystal Lake, IL (US); Steven C Emmert, McHenry, IL (US)

(21) Appl. No.: 15/898,542

(22) Filed: Feb. 17, 2018

(51) Int. Cl. G06F 1/16; G06F 3/0484; G06F 3/0488

(52) U.S. Cl. CPC G06F 1/1681; G06F 3/04883; G06F 3/04845

(57) ABSTRACT

An electronic device includes a linking housing pivotally coupled between two counter-rotatable device housings. The linking housing defines a planar surface extension of the two counter-rotatable device housings when the two counter-rotatable device housings rotate about the linking housing to a closed position where the two counter-rotatable device housings abut. The linking housing defines an orthogonal surface extension from the two counter-rotatable device housings when the two counter-rotatable device housings rotate to an axially displaced open position.

### BACKGROUND

### Technical Field

This disclosure relates generally to electronic devices, and more particularly to electronic devices having hinges.

### Background Art

Mobile electronic communication devices, such as smartphones, tablet computers, and the like, are becoming increasingly popular and are used by many, many people. People use mobile electronic communication devices for many different purposes including, but not limited to, voice communications and data communications for text messaging, Internet browsing, commerce such as banking, and social networking.

These electronic devices are continually becoming smaller, lighter, and thinner. This can present a design challenge to designers trying to incorporate desired features, such as high-resolution cameras, larger displays, or high-capacity batteries, into these devices without compromising compact ergonomics. Consumers want these powerful features, but prefer smaller and lighter devices. It would be advantageous to have an improved electronic device to accommodate such components while still maintaining a compact form factor.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates a perspective view of a first explanatory electronic device in a closed configuration in accordance with one or more embodiments of the disclosure.

FIG. 2 illustrates a top plan view of a first explanatory electronic device in a closed configuration in accordance with one or more embodiments of the disclosure.

FIG. 3 illustrates a front elevation view of a first explanatory electronic device in a closed configuration in accordance with one or more embodiments of the disclosure.

FIG. 4 illustrates a side elevation view of a first explanatory electronic device in a closed configuration in accordance with one or more embodiments of the disclosure.

FIG. 5 illustrates a rear elevation view of a first explanatory electronic device in a closed configuration in accordance with one or more embodiments of the disclosure.

FIG. 6 illustrates a first perspective view of a first explanatory electronic device in an open configuration in accordance with one or more embodiments of the disclosure.

FIG. 7 illustrates a second perspective view of a first explanatory electronic device in an open configuration in accordance with one or more embodiments of the disclosure.

FIG. 8 illustrates a first sectional view of a first explanatory electronic device in a closed configuration in accordance with one or more embodiments of the disclosure.

FIG. 9 illustrates a second sectional view of a first explanatory electronic device in a closed configuration in accordance with one or more embodiments of the disclosure.

FIG. 10 illustrates a first sectional view of a first explanatory electronic device in an open configuration in accordance with one or more embodiments of the disclosure.

FIG. 11 illustrates a second sectional view of a first explanatory electronic device in an open configuration in accordance with one or more embodiments of the disclosure.

FIG. 12 illustrates a first perspective view of a second explanatory electronic device in an open configuration in accordance with one or more embodiments of the disclosure.

FIG. 13 illustrates a second perspective view of a second explanatory electronic device in an open configuration in accordance with one or more embodiments of the disclosure.

FIG. 14 illustrates a side elevation view of a second explanatory electronic device in an open configuration in accordance with one or more embodiments of the disclosure.

FIG. 15 illustrates a front elevation view of a second explanatory electronic device in an open configuration in accordance with one or more embodiments of the disclosure.

FIG. 16 illustrates a second side elevation view of a second explanatory electronic device in an open configuration in accordance with one or more embodiments of the disclosure.

FIG. 17 illustrates a rear elevation view of a second explanatory electronic device in an open configuration in accordance with one or more embodiments of the disclosure.

FIG. 18 illustrates a front elevation view of one explanatory electronic device, in a closed configuration, with a linking housing removed in accordance with one or more embodiments of the disclosure.

FIG. 19 illustrates a rear elevation view of one explanatory electronic device, in a closed configuration, with a linking housing removed in accordance with one or more embodiments of the disclosure.

FIG. 20 illustrates a perspective view of one explanatory electronic device, in a closed configuration, with a linking housing removed in accordance with one or more embodiments of the disclosure.

FIG. 21 illustrates a perspective view of a third explanatory electronic device in a closed configuration in accordance with one or more embodiments of the disclosure.

FIG. 22 illustrates a top plan view of a third explanatory electronic device in a closed configuration in accordance with one or more embodiments of the disclosure.

FIG. 23 illustrates a front elevation view of a third explanatory electronic device in a closed configuration in accordance with one or more embodiments of the disclosure.

FIG. 24 illustrates a side elevation view of a third explanatory electronic device in a closed configuration in accordance with one or more embodiments of the disclosure.

FIG. 25 illustrates a rear elevation view of a third explanatory electronic device in a closed configuration in accordance with one or more embodiments of the disclosure.

FIG. 26 illustrates a first perspective view of a third explanatory electronic device in an open configuration in accordance with one or more embodiments of the disclosure.

FIG. 27 illustrates a second perspective view of a third explanatory electronic device in an open configuration in accordance with one or more embodiments of the disclosure.

FIG. 28 illustrates a top plan view of a third explanatory electronic device in an open configuration in accordance with one or more embodiments of the disclosure.

FIG. 29 illustrates first a side elevation view of a third explanatory electronic device in an open configuration in accordance with one or more embodiments of the disclosure.

FIG. 30 illustrates a front elevation view of a third explanatory electronic device in an open configuration in accordance with one or more embodiments of the disclosure.

FIG. 31 illustrates a second side elevation view of a third explanatory electronic device in an open configuration in accordance with one or more embodiments of the disclosure.

FIG. 32 illustrates a rear elevation view of a third explanatory electronic device in an open configuration in accordance with one or more embodiments of the disclosure.

FIG. 33 illustrates a perspective view of a third explanatory electronic device in a tent, or partially folded, configuration in accordance with one or more embodiments of the disclosure.

FIG. 34 a perspective view of another explanatory electronic device, in a closed configuration, with a linking housing removed in accordance with one or more embodiments of the disclosure.

FIG. 35 illustrates a front elevation view of another explanatory electronic device, in a closed configuration, with a linking housing removed in accordance with one or more embodiments of the disclosure.

FIG. 36 illustrates a rear elevation view of another explanatory electronic device, in a closed configuration, with a linking housing removed in accordance with one or more embodiments of the disclosure.

FIG. 37 illustrates a perspective view of a fourth explanatory electronic device in a closed configuration in accordance with one or more embodiments of the disclosure.

FIG. 38 illustrates a rear elevation view of a fourth explanatory electronic device in a closed configuration in accordance with one or more embodiments of the disclosure.

FIG. 39 illustrates a side elevation view of a fourth explanatory electronic device in a closed configuration in accordance with one or more embodiments of the disclosure.

FIG. 40 illustrates a front elevation view of a fourth explanatory electronic device in a closed configuration in accordance with one or more embodiments of the disclosure.

FIG. 41 illustrates a first perspective view of a fourth explanatory electronic device in an open configuration in accordance with one or more embodiments of the disclosure.

FIG. 42 illustrates a front elevation view of a fourth explanatory electronic device in an open configuration in accordance with one or more embodiments of the disclosure.

FIG. 43 illustrates a side elevation view of a fourth explanatory electronic device in an open configuration in accordance with one or more embodiments of the disclosure.

FIG. 44 illustrates a rear elevation view of a fourth explanatory electronic device in an open configuration in accordance with one or more embodiments of the disclosure.

FIG. 45 illustrates a perspective view of a fourth explanatory electronic device in a tent, or partially folded, configuration in accordance with one or more embodiments of the disclosure.

FIG. 46 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially” and “about” are used to refer to dimensions, orientations, or alignments inclusive of manufacturing tolerances. Thus, a “substantially orthogonal” angle with a manufacturing tolerance of plus or minus two degrees would include all angles between 88 and 92, inclusive. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide a bendable electronic device that includes a flexible display and a housing assembly that comprises one or more hinges. In one or more embodiments, the housing assembly comprises a linking housing pivotally coupled by one or more hinges between two counter-rotatable device housings. In one embodiment, the linking housing is pivotally coupled between a first device housing and a second device housing. The inclusion of the hinge(s) and linking housing allows the overall electronic device to be deformed by one or more bends.

Illustrating by example, the electronic device can operate in a first configuration where housing portions lie in the same plane. When this occurs, i.e., when the two counter-rotatable device housings rotate to an axially displaced open position, in one or more embodiments the linking housing defines a substantially orthogonal surface extension from the two counter-rotatable device housings. Said differently, when the electronic device is in the open position, the linking housing extends substantially orthogonally from major outer faces of the first device housing and the second device housing.

In one or more embodiments, this same electronic device can then be deformed into a folded configuration where housing portions are disposed adjacent to each other. In one or more embodiments, when this occurs, i.e., when the two counter-rotatable device housings rotate about the linking housing and the hinge to a closed position where the two counter-rotatable housings abut, the linking housing defines a planar surface extension of the major outer faces of the first device housing and the second device housing. In one or more embodiments, the same electronic device can also be deformed into a bent configuration, such as a tent configuration.

In one or more embodiments, an electronic device comprises a first device housing having a first device housing exterior surface and a second device housing comprising a second device housing exterior surface. A linking device housing is hingedly coupled between the first device housing and the second device housing. In one or more embodiments, the linking device housing defines an extension of each of the first device housing exterior surface and the second device housing exterior surface when the first device housing and the second device housing pivot about the linking device housing to a closed position. In one or more embodiments, the linking device housing extends substantially orthogonally from the first device housing and the second device housing when the first device housing and the second device housing pivot about the linking device housing from the closed position to an angularly displaced open position.

In another embodiment, an electronic device comprises a first device housing having a first device housing exterior surface and a second device housing having a second device housing exterior surface. A linking device housing is hingedly coupled between the first device housing and the second device housing. In one or more embodiments, the linking device housing comprises a first major face and a second major face. In one or more embodiments, the first major face is substantially coplanar with the first device housing exterior surface when the first device housing and the second device housing pivot about the linking device housing to a closed position where the first device housing and the second device housing abut. In one or more embodiments, the first major face is substantially perpendicular with the first device housing exterior surface when the first device housing and the second device housing pivot about the linking device housing from the closed position to an open position where the first device housing and the second device housing are substantially coplanar.

This combination of two counter-rotatable housings attached to a central linking device housing offers many advantages over prior art designs. Illustrating by example, in one or more embodiments a rechargeable battery can be disposed within one of the device housings, along with an interior facing display. This causes the center of gravity of the electronic device to move to device housing having the rechargeable battery. This “bottom weighted” design advantageously makes the device housing having the rechargeable battery to be heavier, thereby making the electronic device pivot toward the device housing having the rechargeable battery with the linking device housing serving as a fulcrum. This “tilted” arrangement makes the displays easier for a user to see when the electronic device is resting on a flat surface in the open configuration in one or more embodiments.

Small components, such as thin loudspeakers and thin microphones, can be placed in the first device housing and the second device housing, along with one or more displays, while maintaining a very thin and light form factor. However, in one or more embodiments larger components, such as high-resolution imagers, can be placed within the linking device housing. Similarly, other large component such as high-powered loudspeakers, directional microphone arrays requiring multiple microphones at orthogonal vectors and separated a certain distance apart, infrared, flood, and structured light sensor components, certain biometric sensors, and other large components can be placed in the linking device housing. These are examples only, as other components particularly well suited for disposition within the linking device housing will be obvious to those of ordinary skill in the art having the benefit of this disclosure.

In one or more embodiments, the linking device housing is modular. This allows the linking device housing to be detached from the two counter-rotatable housings so that another can be attached in its place. For example, a “projector” linking device housing that includes a light projector can be interchanged with a “music” linking device housing that includes high-powered stereo loudspeakers, and so forth.

Moreover, the linking device housing—when the electronic device is open—advantageously serves as a “handle” that can be captured between two fingers to make holding the electronic device easier. In one or more embodiments, an indent feature can be added to one of the first device housing or the second device housing to make it easier for the first device housing and the second device housing pivot about the linking device housing from the closed position to an open position where the first device housing and the second device housing are substantially coplanar.

In one or more embodiments, the linking device housing counter-rotates relative to each device housing by about ninety degrees in one embodiment as the first device housing and the second device housing pivot about the linking device housing from the closed position to an open position where the first device housing and the second device housing are substantially coplanar. However, in one or more embodiments the linking device housing aligns with the ends of the exterior surfaces of each of the first device housing and the second device housing when the first device housing and the second device housing pivot about the linking device housing to a closed position where the first device housing and the second device housing abut. Such a form factor supports both portrait and landscape formats of display(s) disposed along the interior of the electronic device, whether a single, foldable display or two adjacent displays.

In one or more embodiments, the linking device housing couples the first device housing to the second device housing such that the first device housing is pivotable about the linking device housing relative to the second device housing to one or more of a bent configuration, a folded configuration, or other configuration. In one or more embodiments, a flexible display is coupled to the first device housing and the second device housing and spans the linking device housing. The flexible display deforms when the first device housing pivots about the linking device housing relative to the second device housing. In other embodiments, each of the first device housing and the second device housing can have a separate display that situate to be adjacent when the first device housing pivots about the linking device housing relative to the second device housing to the open position.

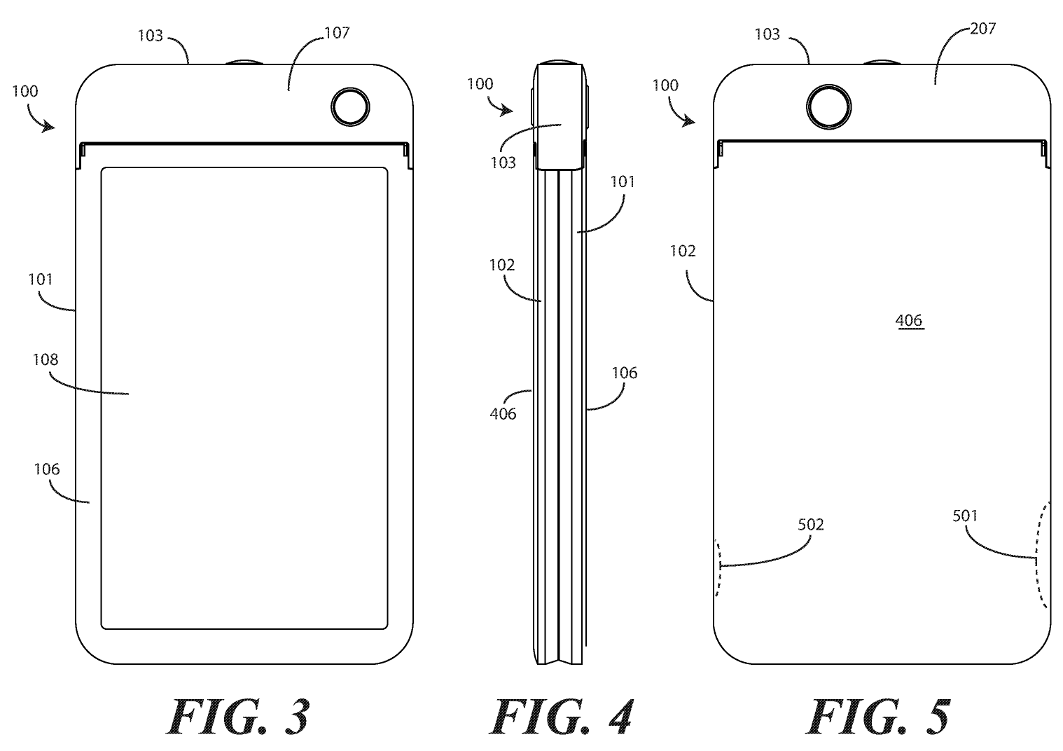

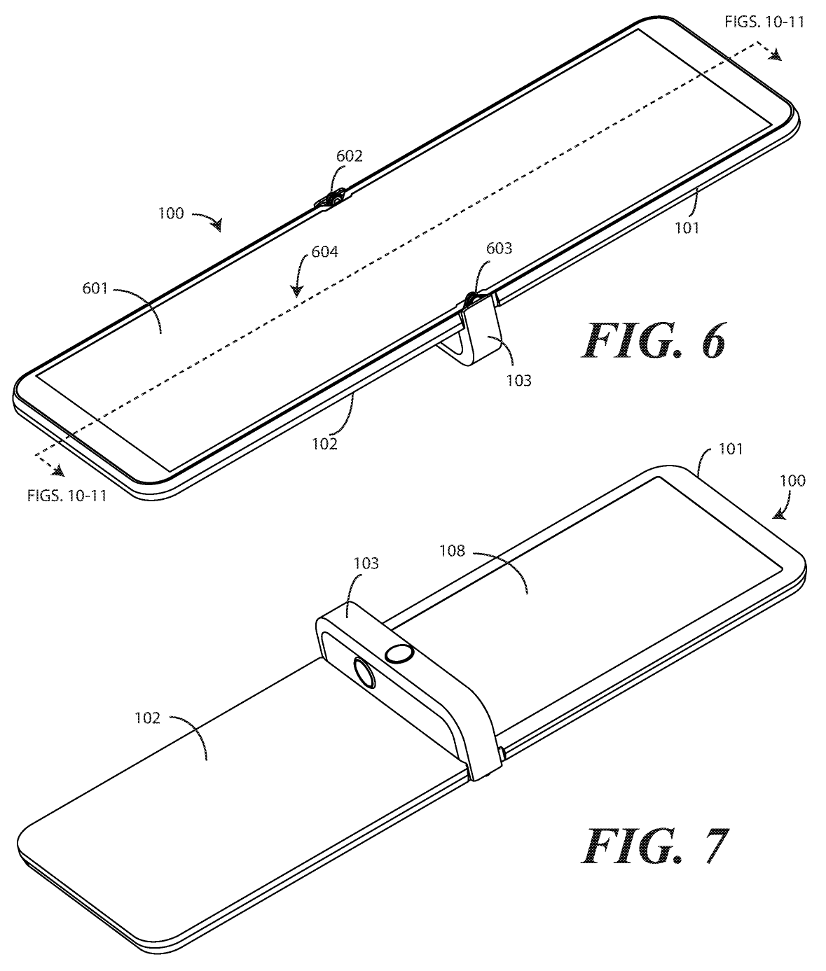

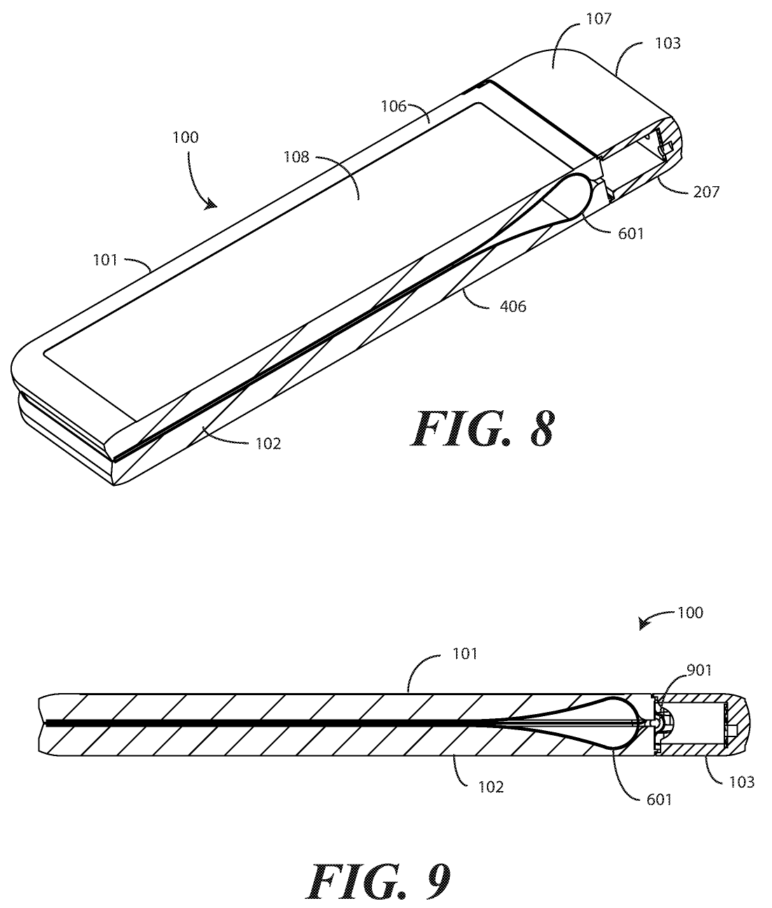

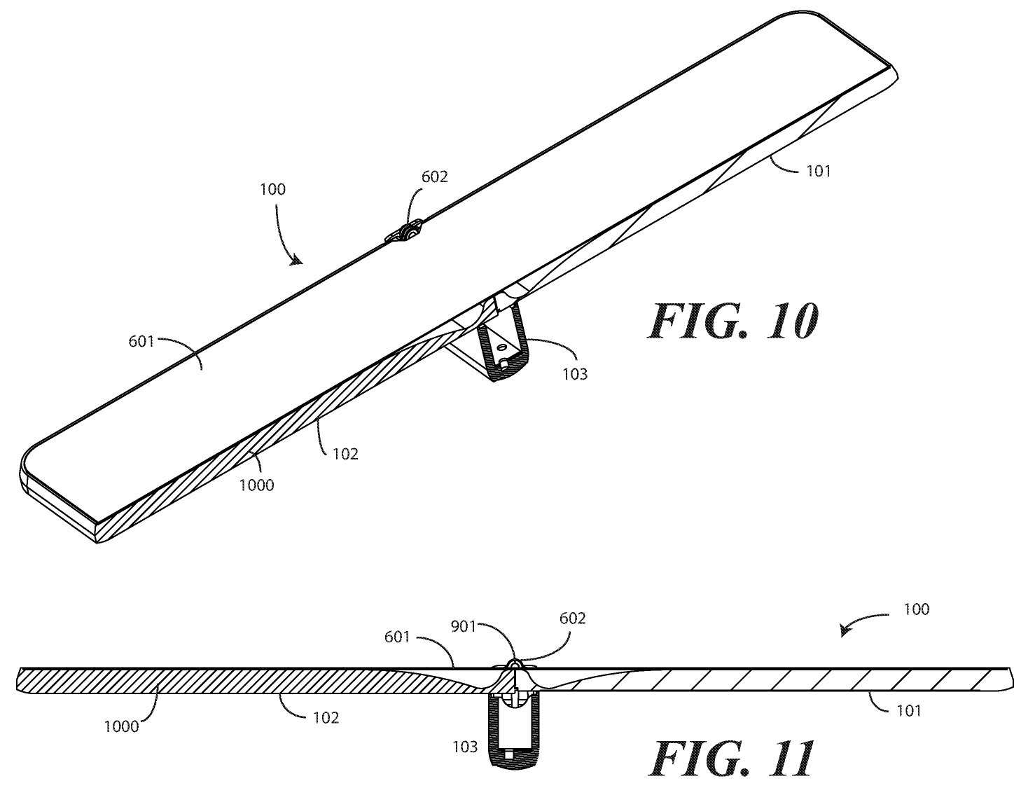

Turning now to FIGS. 1-11, illustrated therein is one explanatory electronic device 100 configured in accordance with one or more embodiments of the disclosure. The electronic device 100 of FIGS. 1-11 is a portable electronic device. As will be described in more detail below, the inclusion of a linking device housing 103 between a first device housing 101 and a second device housing 102 allows the electronic device 100 to be bent or folded. For example, the electronic device 100 is shown in a closed position in FIGS. 1-5 and 8-9 where the first device housing 101 and the second device housing 102 have been rotated about the linking device housing 103 to a closed position where the first device housing 101 and the second device housing 102 abut. By contrast, FIGS. 6-7 and 10-11 illustrate the electronic device 100 in an open position, where the first device housing 101 and the second device housing 102 have been rotated about the linking device housing 103 from the closed position to an axially displaced open position.

In one or more embodiments, the electronic device 100 includes an interior display 601, which may optionally be touch-sensitive. In one embodiment where the interior display 601 is touch-sensitive, the interior display 601 can serve as a primary user interface of the electronic device 100. Users can deliver user input to the interior display 601 of such an embodiment by delivering touch input from a finger, stylus, or other objects disposed proximately with the display.

In one embodiment, the interior display 601 is configured as an organic light emitting diode (OLED) display fabricated on a flexible plastic substrate. However, it should be noted that other types of displays would be obvious to those of ordinary skill in the art having the benefit of this disclosure. In one or more embodiments, an OLED is constructed on flexible plastic substrates can allow the interior display 601 to become flexible in one or more embodiments with various bending radii. For example, some embodiments allow bending radii of between thirty and six hundred millimeters to provide a bendable display. Other substrates allow bending radii of around five millimeters to provide a display that is foldable through active bending. Other displays can be configured to accommodate both bends and folds. In one or more embodiments the interior display 601 may be formed from multiple layers of flexible material such as flexible sheets of polymer or other materials.

The explanatory electronic device 100 of FIGS. 1-11 also includes a housing assembly. In one or more embodiments, the housing assembly comprises three different housing members: a first device housing 101, a second device housing 102, and a linking device housing 103. In this illustrative embodiment, each of the first device housing 101, the second device housing 102, and the linking device housing 103 have a common, coextensive width 109 due to the fact that the width of the linking device housing 103 is the same as the respective widths of each of the first device housing 101 and the second device housing 102.

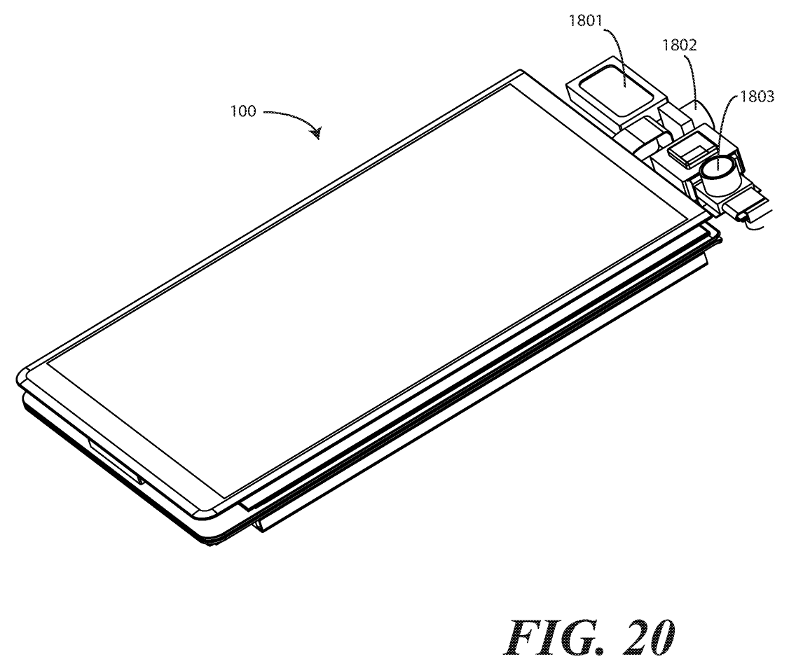

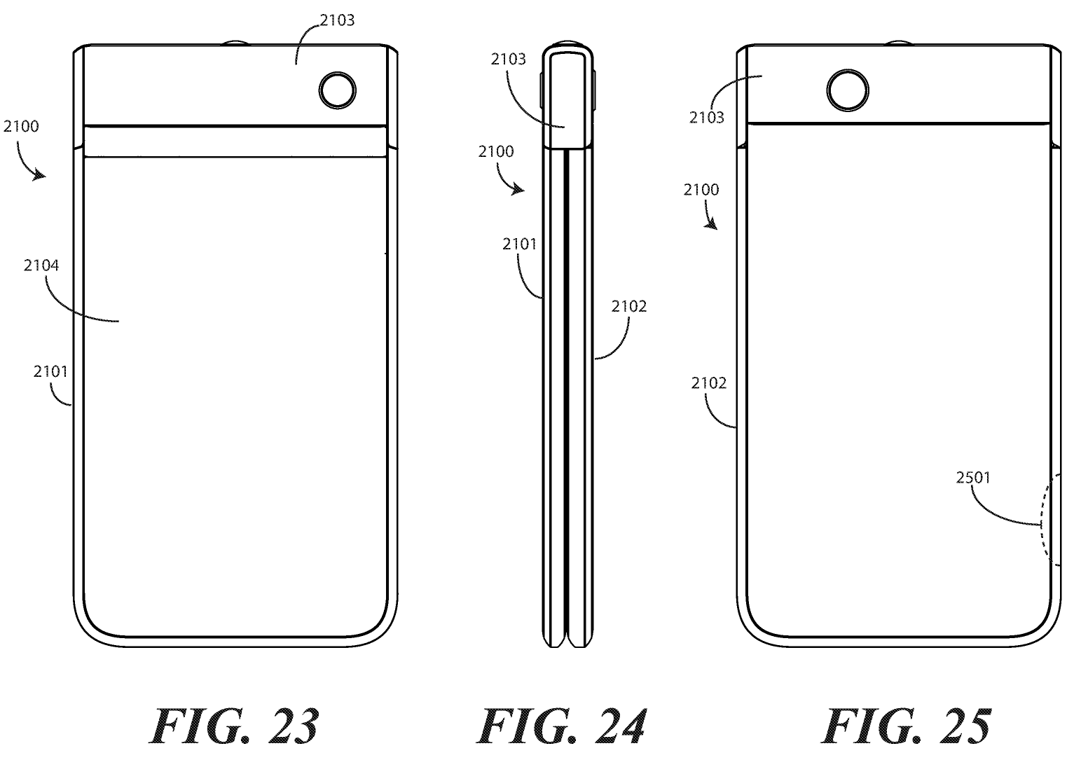

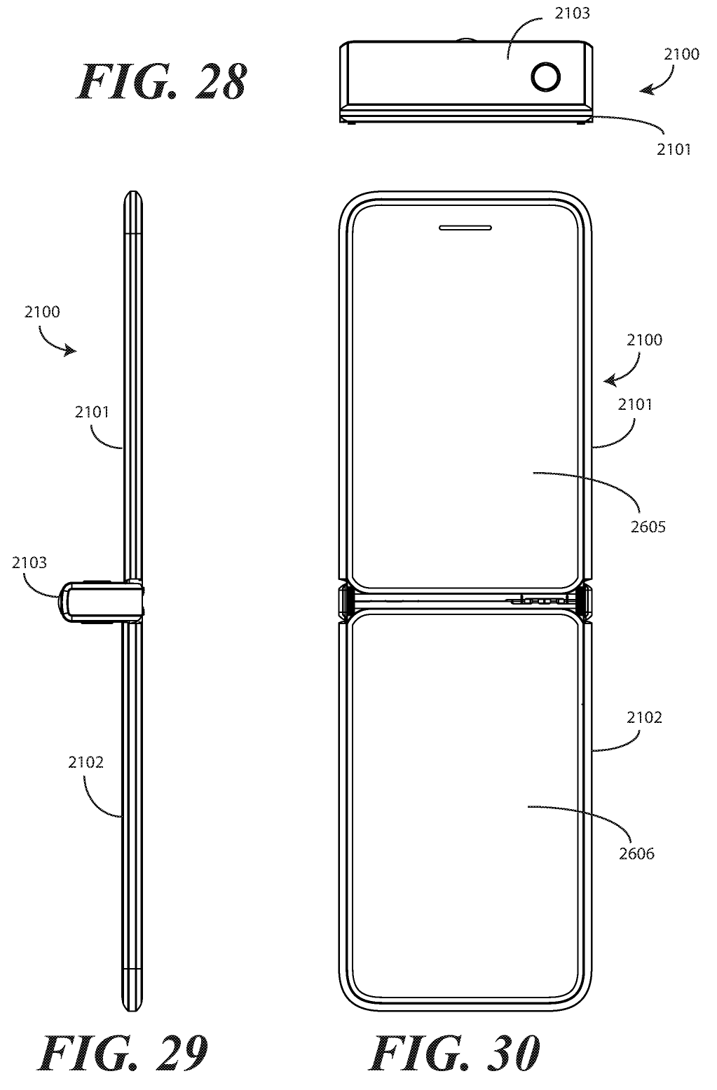

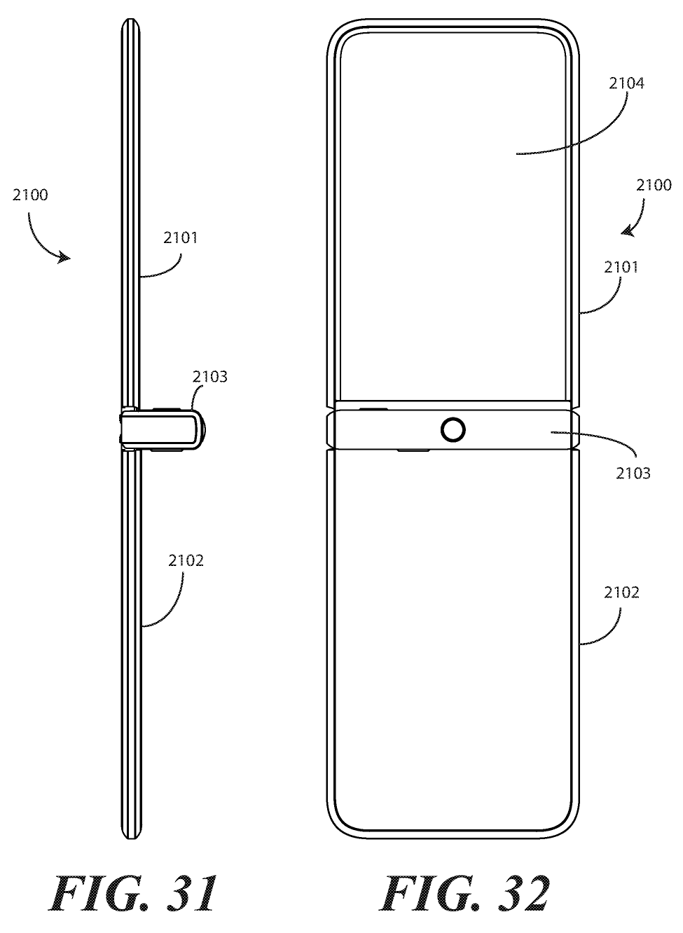

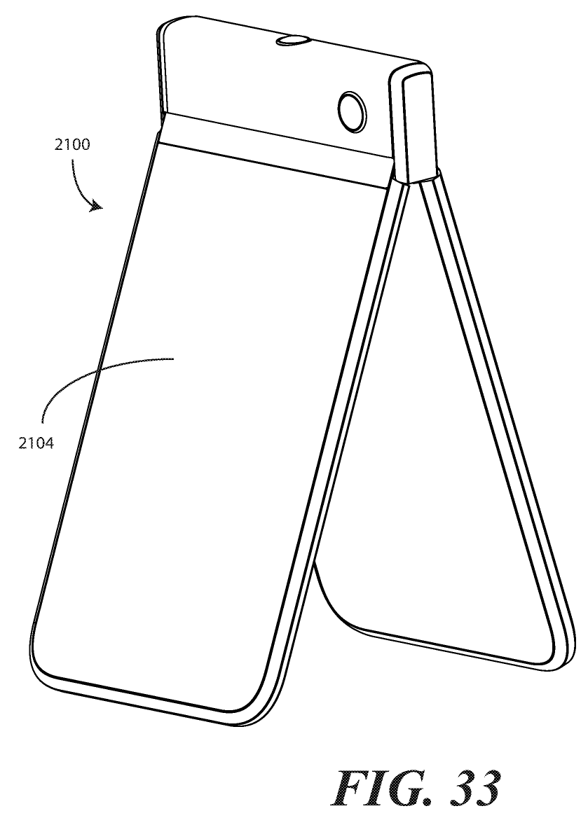

In this illustrative embodiment, the linking device housing 103 is pivotally coupled between the first device housing 101 and the second device housing 102 by one or more hinges. In the illustrative embodiment of FIGS. 1-11, the electronic device includes a single-axis hinge defined by hinge fulcrums 602,603 and rotation pin 901. However, as will be shown with reference to FIGS. 20-32 below, two or more hinge axes can be incorporated into other electronic devices. The hinge facilitates a counter rotation of each of the first device housing 101 and the second device housing 102 relative to the linking device housing 103 by about ninety-degrees when the first device housing 101 and the second device housing 102 pivot about the linking device housing 103 from the closed position to the angularly displaced open position.

As best seen in FIG. 9, in one or more embodiments a rotation pin 901 can be coupled between the one or more hinge fulcrums 602,603 to define an axis of rotation and serve as a mechanical axle about which the first device housing 101 and the second device housing 102 may pivot relative to each other and relative to the linking device housing 103. Thus, in one or more embodiments the electronic device 100 includes a hinge, which in this illustration is a single-axis hinge, which is disposed within the linking device housing 103, and which pivotally coupling the two counter-rotatable device housings to the linking device housing 103.

In one or more embodiments, the first device housing 101 and the second device housing 102 function as two counter-rotatable device housings. They are counter-rotatable because when transitioning from the closed position, shown in FIG. 1, to the open position, shown in FIG. 6, or from the open position to the closed position, they rotate in opposite directions. For example, when transitioning from the closed position to the open position, the first device housing 101 rotates in a first direction 104 relative to the linking device housing 103, while the second device housing 102 rotates in a second direction 105 relative to the linking device housing 103. When transitioning from the open position to the closed position, the first device housing 101 rotates in a direction opposite the first direction 104 relative to the linking device housing 103, while the second device housing 102 rotates in a direction opposite the second direction 105 relative to the linking device housing 103. Accordingly, when the linking device housing 103 is pivotally coupled between the first device housing 101 and the second device housing 102 as shown in FIGS. 1-11, the first device housing 101 and the second device housing 102 define two counter-rotatable device housings.

With the linking device housing 103 pivotally coupled between these two counter-rotatable device housings, this allows the first device housing 101 to be pivotable about the linking device housing 103 relative to the second device housing 102 so that the electronic device 100 becomes bendable and/or foldable. In one or more embodiments, each of the first device housing 101, the second device housing 102, and the linking device housing 103 are manufactured from a rigid material such as a thin, rigid metal. Other materials, such as rigid thermoplastics or composite materials, might be used in other applications. Still other constructs will be obvious to those of ordinary skill in the art having the benefit of this disclosure.

As shown in FIGS. 1-6, in one or more embodiments, the linking device housing 103 defines a planar surface extension of the first device housing 101 and the second device housing 102 when these two counter-rotatable device housings rotate about the linking device housing 103 to the closed position where the two counter-rotatable device housings abut. In this illustrative embodiment, the first device housing 101 has an exterior surface defined by a first device housing outer surface 106, while the second device housing 102 has an exterior surface defined by a second device housing outer surface 406. Similarly, the linking device housing 103 has a first major face and a second major face. The first major face defines a first linking housing outer surface 107, while the second major face defines a second linking housing outer surface 207.

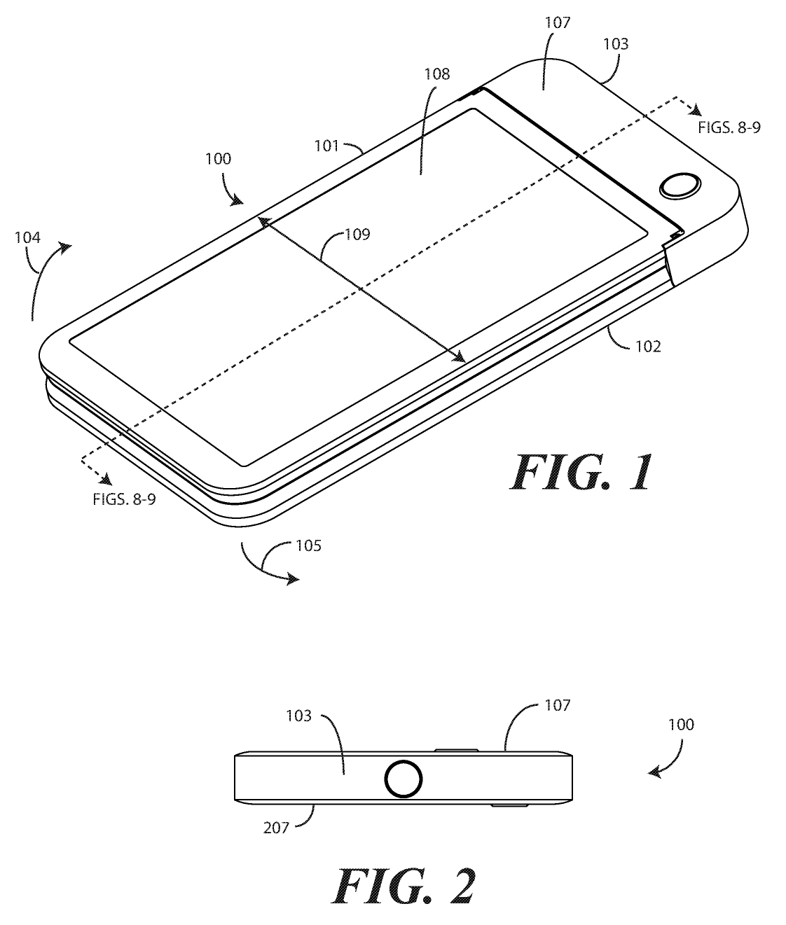

The linking device housing 103 defines a planar surface extension of the first device housing 101 and the second device housing 102 when these two counter-rotatable device housings rotate about the linking device housing 103 to the closed position because the first linking housing outer surface 107 and the second linking housing outer surface 207 define an extension of the first device housing outer surface 106 and the second device housing outer surface 406, respectively. Said differently, the first major face defining the first linking housing outer surface 107 is substantially coplanar with the first device housing outer surface 106 when the first device housing 101 and the second device housing 102 pivot about the linking device housing 103 to the closed position where the first device housing 101 and the second device housing 102 abut. Similarly, the second major face defining the second linking housing outer surface 207 is substantially coplanar with the second device housing outer surface 406 when the first device housing 101 and the second device housing 102 pivot about the linking device housing 103 to the closed position where the first device housing 101 and the second device housing 102 abut. This is best seen in FIGS. 2 and 4.

In this illustrative embodiment, the interior display 601 is coupled to the first device housing 101 and the second device housing 102. The internal display 601 spans the linking device housing 103. In one or more embodiments, the lower surface of the interior display 601, or another layer in the mechanical stack-up of the interior display 601, can be adhered to the first device housing 101 and the second device housing 102, or alternatively to portions of the first device housing 101 and the second device housing 102. In either embodiment, the interior display 601 also spans the linking device housing 103. In one or more embodiments the interior display 601 is flexible so as to deform when the first device housing 101 pivots about the linking device housing 103 relative to the second device housing 102.

In one or more embodiments, an indent feature, which can be defined by a recess or indent 501,502 about the perimeter of one of the first device housing 101 or the second device housing 102 can be added to assist in opening the electronic device 100. In FIG. 5, indent 501 and indent 502 in the second device housing 102 provide recesses into which a user could insert the tip of a finger or a finger nail to make contact with, and apply pressure to, the first device housing 101 to initiate the rotation from the closed position where the first device housing 101 and the second device housing 102 abut to the open position where the first device housing 101 and the second device housing 102 are substantially coplanar. The inclusion of an indent 501,502, which is optional, effectively can make it easier for a user to start the first device housing 101 and the second device housing 102 pivoting about the linking device housing 103 from the closed position to the open position where the first device housing 101 and the second device housing 102 are substantially coplanar.

In one or more embodiments, when the two counter-rotatable device housings defined by the first device housing 101 and the second device housing 102 rotate to the axially displaced open position shown in FIGS. 6-7 and 10-11, the linking device housing 103 defines an orthogonal surface extension from the first device housing 101 and the second device housing 102. Said differently, when the first device housing 101 and the second device housing 102 pivot about the linking device housing 103 from the closed position of FIGS. 1-5 and 8-9 to the angularly displaced open position of FIGS. 6-7 and 10-11, the linking device housing 103 extends substantially orthogonally from the first device housing 101 and the second device housing 102.

This occurs, in one or more embodiments, because the first major face of the linking device housing 103 defined by the first linking housing outer surface 107 becomes substantially perpendicular with the first device housing outer surface 106 when the first device housing 101 and the second device housing 102 pivot about the linking device housing 103 from the closed position to the open position where the first device housing 101 and the second device housing 102 are substantially coplanar, as shown in FIGS. 6-7 and 10-11. Similarly, the second major face of the linking device housing 103 defined by the second linking housing outer surface 207 becomes substantially perpendicular with the second device housing outer surface 406 when the first device housing 101 and the second device housing 102 pivot about the linking device housing 103 from the closed position to the open position where the first device housing 101 and the second device housing 102 are substantially coplanar.

Thus, as shown in FIGS. 1-11, the first device housing 101 and the second device housing 102 rotate radially by 180-degrees when transitioning from the closed position where the first device housing 101 and the second device housing 102 abut to the open position where the first device housing 101 and the second device housing 102 are substantially coplanar. At the same time, the linking device housing 103 rotates only about 90-degrees from the upper part of the closed electronic device to the middle, and rear, of the open electronic device. Accordingly, when the first device housing 101 and the second device housing 102 pivot about the linking device housing 103 from the closed position to the open position where the first device housing 101 and the second device housing 102 are substantially coplanar, the electronic device 100 defines a “T” shape, with the linking device housing 103 defining the base of the T-shape, and the first device housing 101 and the second device housing 102, which are substantially coplanar in the open position, define the top, horizontal member of the T-shape.

This construct that includes two counter-rotatable device housings pivotally attached to the linking device housing 103 offers numerous advantages over prior art designs. By defining the T-shape, the electronic device 100 in the open position offers numerous advantageous ways to hold the electronic device 100 in the hand. As such, the linking device housing 103—when the electronic device 100 is open—advantageously serves as a “handle” that can be captured between a user's fingers to make holding the electronic device 100 easier. Illustrating by example, in one embodiment a user may simply pinch the base of the T-shape between their forefinger and index finger to hold the electronic device 100 effortlessly in their hand.

In a different embodiment, a user may grip the sides of the electronic device 100 with their palm and one or more of their third finger, ring finger, and little finger, while resting the index finger on the base of the T-shape. By applying slight pressure against the base of the T-shape, the user can pull the electronic device 100 toward the palm, thereby ensuring a more stable and secure grip than would occur when holding the electronic device 100 only by the sides. This is true because rather than two force vectors gripping the electronic device at the right and left, four force vectors work toward the center of the second device housing 102.

In still another embodiment, a user can grip the electronic device by placing the thumb on one end of the base of the T-shape and one or more fingers on the other end of the base of the T-shape. This allows the electronic device 100 to be securely held without the necessity of gripping either the first device housing 101 or the second device housing 102.

Features can be incorporated into the first device housing 101 and/or the second device housing 102. Examples of such features include an optional camera or an optional speaker port. A user interface component, which may be a button or touch sensitive surface, can also be disposed along the first device housing 101 or the second device housing 102. Small components, such as thin loudspeakers and thin microphones, can be placed in the first device housing 101 and the second device housing 102, along with one or more displays, while maintaining a very thin and light form factor.

The electronic device 100 can include internal components that perform the operational functionality of the electronic device 100. These internal components can include one or more processors. The one or more processors can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device.

The application processor and the auxiliary processor(s) can be operable with the various components of the electronic device 100. Each of the application processor and the auxiliary processor(s) can be configured to process and execute executable software code to perform the various functions of the electronic device 100. A storage device, such as a memory, can optionally store the executable software code used by the one or more processors during operation.

The electronic device 100 can also include a communication circuit for wired or wireless communication with one or more other devices or networks. The networks can include a wide area network, a local area network, and/or personal area network. Examples of wide area networks include GSM, CDMA, W-CDMA, CDMA-2000, iDEN, TDMA, 2.5 Generation 3GPP GSM networks, 3rd Generation 3GPP WCDMA networks, 3GPP Long Term Evolution (LTE) networks, and 3GPP2 CDMA communication networks, UMTS networks, E-UTRA networks, GPRS networks, iDEN networks, and other networks.

The communication circuit may also utilize wireless technology for communication, such as, but are not limited to, peer-to-peer or ad hoc communications such as HomeRF, Bluetooth and IEEE 802.11 (a, b, g or n), and other forms of wireless communication such as infrared technology. The communication circuit can include wireless communication circuitry, one of a receiver, a transmitter, or transceiver, and one or more antennas.

The electronic device 100 can include one or more flex sensors, operable with the one or more processors, to detect a bending operation that causes the first device housing 101 to pivot about the linking device housing 103 relative to the second device housing 102, thereby transforming the electronic device 100 into a deformed geometry. The inclusion of flex sensors is optional, and in some embodiment flex sensors will not be included.

In one or more embodiments, an energy storage device 1000, such as a rechargeable lithium-ion, lithium-polymer, or other type of battery, can be disposed within the first device housing 101. In one or more embodiments, this causes the center of gravity 604 of the overall electronic device 100 to move to the side of the linking device housing 103 containing the energy storage device 1000. In this “bottom weighted” design, a user can more readily see the interior display 601 when the electronic device 100 is placed on a flat surface. As best shown in FIG. 6, this causes the first device housing 101 to “tip” downward, with the linking device housing 103 serving as a fulcrum. When the user is situated on the first device housing side, this makes the electronic device 100 toward the user, thereby making the interior display 601 easier for the user to see. Accordingly, in one or more embodiments, the first device housing 101 and a center of gravity 604 of the electronic device 100 are on a common side of the linking device housing 103 when the two counter-rotatable device housings rotate to the axially displaced open position.

In one or more embodiments, in addition to the interior display 601, one or more additional displays can be included as well. In the illustrative embodiment of FIGS. 1-11, the second device housing 102 comprises a second display 108 coupled to its major face. Embodiments of the disclosure contemplate that users may desire to see information such as notifications of incoming messages, caller identification, time of day, weather information, and so forth without opening the electronic device 100. Accordingly, in one or more embodiments the addition of a second display 108, which is externally facing when the two counter-rotatable device housings defined by the first device housing 101 and the second device housing 102 rotate about the linking device housing 103 to the closed position where the first device housing 101 and the second device housing 102 abut, allows a user to see such information without the necessity of rotating the first device housing 101 and the second device housing 102 about the linking device housing 103 to the axially displaced open position.

As with the interior display 601, the second display 108 can be touch sensitive. In one embodiment, the second display 108 is configured as an organic light emitting diode (OLED) display fabricated on a substrate. In other embodiments, however, the second display 108 can be a lower resolution or can consume less power than the interior display 601. In some applications, a user may wish to see only basic information on the second display 108, preferring to view more detailed or higher resolution information on the larger interior display 601. To satisfy the desires of such users, the interior display 601 can be a high-resolution display, while the second display 108 has lower resolution or consumes less power. In still other embodiments, the second display can be an electrophoretic display, “e-ink” display, or other display that consumes to little to no power when the electronic device 100 is closed.

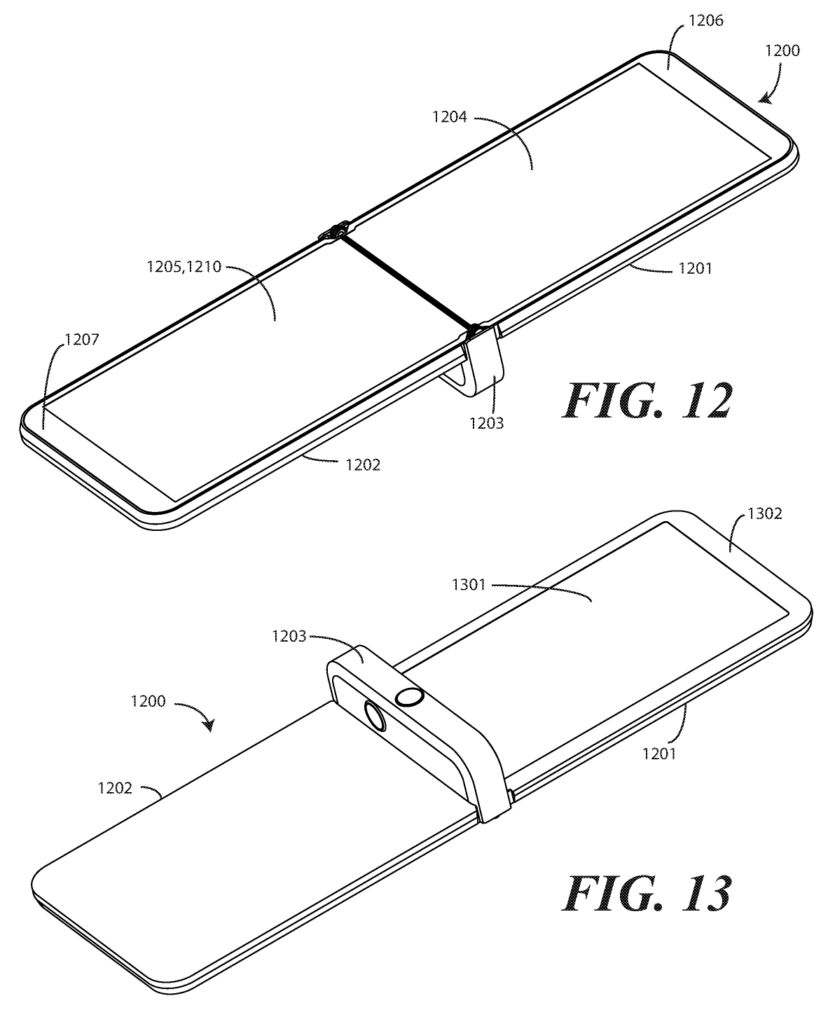

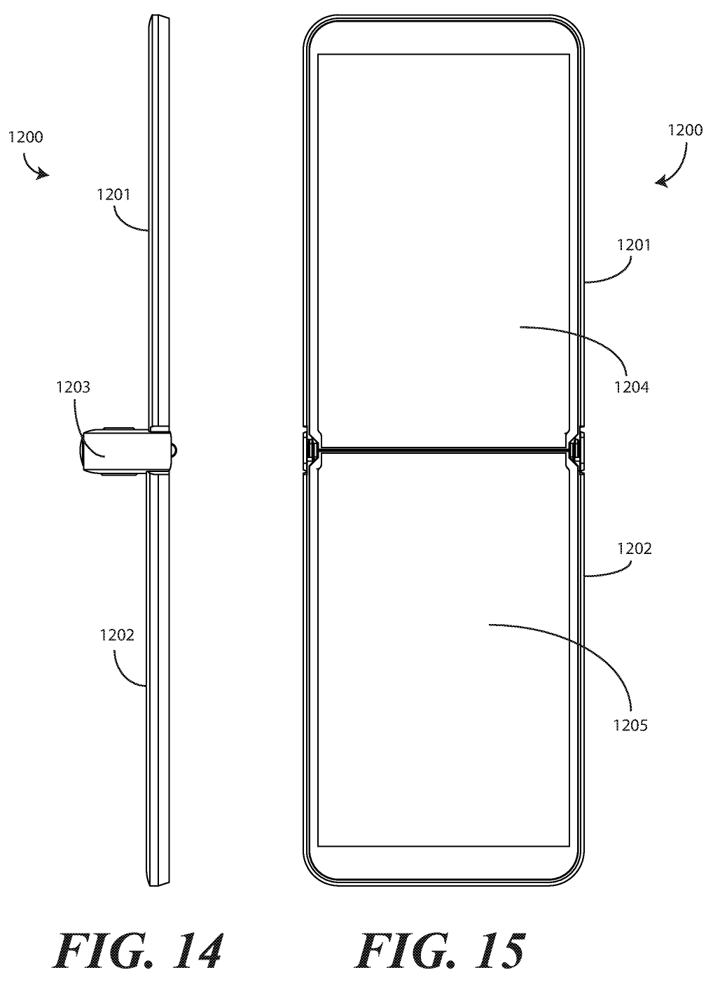

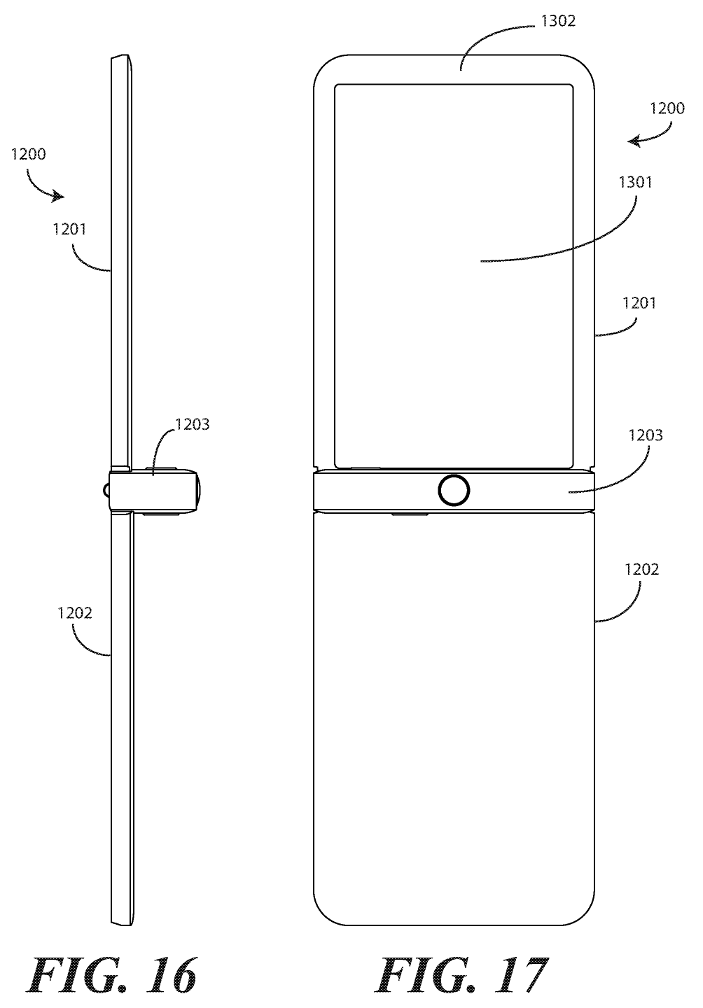

In the illustrative embodiment of FIGS. 1-11, the interior display 601 is coupled to the first device housing 101 and the second device housing 102. The interior display 601 additionally spans the linking device housing 103. However, in other embodiments the interior display 601 can be replaced by one or more displays. In still other embodiments, the interior display 601 can be replaced by a combination of displays and other devices, such as physical keypads, loudspeakers, or other user interface devices. Turning now to FIGS. 12-17, illustrated therein is one such electronic device 1200.

The electronic device 1200 of FIGS. 12-17 includes many of the features of the electronic device (100) of FIGS. 1-11. Illustrating by example, the electronic device 1200 of FIGS. 12-17 include a linking device housing 1203 between a first device housing 1201 and a second device housing 1202 allows the electronic device 1200 to be bent or folded. As before, the linking device housing 1203 is pivotally coupled between the first device housing 1201 and the second device housing 1202 by one or more hinges. In this embodiment, the hinge is a single-axis hinge, which is disposed within the linking device housing 1203, and which pivotally coupling the two counter-rotatable device housings to the linking device housing 1203.

When transitioning from the closed position to the open position, the first device housing 1201 rotates in a first direction relative to the linking device housing 1203, while the second device housing 1202 rotates in a second direction relative to the linking device housing 1203. When transitioning from the open position to the closed position, the first device housing 1201 rotates in a direction opposite the first direction relative to the linking device housing 1203, while the second device housing 1202 rotates in a direction opposite the second direction relative to the linking device housing 1203.

As before, the linking device housing 1203 defines a planar surface extension of the first device housing 1201 and the second device housing 1202 when these two counter-rotatable device housings rotate about the linking device housing 1203 to the closed position where the two counter-rotatable device housings abut. In one or more embodiments, when the first device housing 1201 and the second device housing 1202 rotate to the axially displaced open position shown in FIGS. 12-17, the linking device housing 1203 defines an orthogonal surface extension from the first device housing 1201 and the second device housing 102. Said differently, when the first device housing 1201 and the second device housing 1202 pivot about the linking device housing 1203 from the closed position to the angularly displaced open position, the linking device housing 1203 extends substantially orthogonally from the first device housing 1201 and the second device housing 1202.

Instead of including a singular, internal display that is coupled to the first device housing 1201 and the second device housing 1202, thereby spanning the linking device housing 1203, in this illustrative embodiment two displays 1204,1205 are include on the interior of the electronic device 100. The use of two displays 1204,1205, instead of a single flexible display, allows for each of the displays 1204,1205 to be fabricated on rigid substrates. Since the displays 1204,1205 do not have to bend, manufacturing and other costs are reduced.

In this illustrative embodiment, a first display 1204 is coupled to a first major face 1206 of the first device housing 1201, while a second display 1205 is coupled to a first major face 1207 of the second device housing 1202. One or both of the first display 1204 and the second display 1205 may optionally be touch-sensitive. In one embodiment, one or both of the first display 1204 and the second display 1205 is configured as an organic light emitting diode (OLED) display fabricated on a rigid or semi-rigid plastic substrate. However, it should be noted that other types of displays would be obvious to those of ordinary skill in the art having the benefit of this disclosure.

In one or more embodiments, either or both of the first display 1204 or the second display 1205 can be replaced with another device, such as a physical keypad, one or more loudspeakers, a projector, or other user interface devices. Illustrating by example, in one or more embodiments the electronic device 1200 comprises a first display 1204 coupled to a first major face 1206 of the first device housing 1201 and a physical keypad 1210 coupled to a first major face 1207 of the second device housing 1202 instead of the second display 1205. Other devices can be substituted for the physical keypad 1210, as will be obvious to those of ordinary skill in the art having the benefit of this disclosure.

In this illustrative embodiment, the first device housing 1201 also includes a third display 1301. In this illustrative embodiment, the first display 1204 is coupled to the first major face 1206 of the first device housing 1201, while the third display 1301 is coupled to a second major face 1302 of the first device housing 1201. In this embodiment, the first major face 1206 is the interior major face, just as the first major face 1207 of the second device housing 1202 is an interior major face, while the second major face 1302 of the first device housing 1201 is an exterior major face.

As with the second display (108) of the embodiment of FIGS. 1-11, the third display 1301 can be a fully functional, high-resolution display in one embodiment. In other embodiments, the third display 1301 can present more basic information such as notifications of incoming messages, caller identification, time of day, weather information, and so forth without opening the electronic device 1200. As with the two internal displays 1204,1205, the third display 1301 can be touch sensitive. In one embodiment, the third display 1301 is configured as an organic light emitting diode (OLED) display fabricated on a substrate. In other embodiments, however, the third display 1301 can be a lower resolution or can consume less power than the two internal displays 1204,1205. In some embodiments, the two internal displays 1204,1205 can be high-resolution displays, while the third display 1301 has lower resolution or consumes less power, as previously described. In still other embodiments, the third display 1301 can be an electrophoretic display, “e-ink” display, or other display that consumes to little to no power when the electronic device 1200 is closed.

Features can be incorporated into the first device housing 1201 and/or the second device housing 1202. Examples of such features include an optional camera or an optional speaker port.

A user interface component, which may be a button or touch sensitive surface, can also be disposed along the first device housing 1201 or the second device housing 1202. Small components, such as thin loudspeakers and thin microphones, can be placed in the first device housing 1201 and the second device housing 1202, along with an energy storage device and/or one or more displays, while maintaining a very thin and light form factor.

In one or more embodiments, the first device housing 1201 and the second device housing 1202 rotate radially by 180-degrees when transitioning from the closed position where the first device housing 1201 and the second device housing 1202 abut to the open position where the first device housing 1201 and the second device housing 1202 are substantially coplanar as shown in FIGS. 12-17. At the same time, the linking device housing 1203 rotates only about 90-degrees from the upper part of the closed electronic device to the middle, and rear, of the open electronic device. Accordingly, when the first device housing 1201 and the second device housing 1202 pivot about the linking device housing 1203 from the closed position to the open position where the first device housing 1201 and the second device housing 1202 are substantially coplanar, the electronic device 1200 defines a “T” shape, with the linking device housing 1203 defining the base of the T-shape, and the first device housing 1201 and the second device housing 1202, which are substantially coplanar in the open position, define the top, horizontal member of the T-shape.

As before, this construct that includes two counter-rotatable device housings pivotally attached to the linking device housing 1203 offers numerous advantages over prior art designs. By defining the T-shape, the electronic device 1200 in the open position offers numerous advantageous ways to hold the electronic device 1200 in the hand. As such, the linking device housing 1203—when the electronic device 1200 is open—advantageously serves as a “handle” that can be captured between a user's fingers to make holding the electronic device 1200 easier. A user can grasp the electronic device 1200 in the same manner as described above with reference to the electronic device (100) of FIGS. 1-11.

In addition to making the either the electronic device (100) of FIGS. 1-11 or the electronic device 1200 of FIGS. 12-17 easier to hold, and further in addition to making either the interior display (601) of the electronic device (100) of FIGS. 1-11 or the two displays 1204,1205 of the electronic device 1200 of FIGS. 12-17 easier to see when in the open position, the inclusion of either the linking device housing (103) of the electronic device (100) of FIGS. 1-11 or the linking device housing 1203 of the electronic device 1200 of FIGS. 12-17 offers other advantages as well. To wit, larger components, such as high-resolution imagers, can be placed within either the linking device housing (103) of the electronic device (100) of FIGS. 1-11 or the linking device housing 1203 of the electronic device 1200 of FIGS. 12-17. Similarly, other large component such as high-powered loudspeakers, directional microphone arrays requiring multiple microphones at orthogonal vectors and separated a certain distance apart, infrared, flood, and structured light sensor components, certain biometric sensors, and other large components can be placed in the either the linking device housing (103) of the electronic device (100) of FIGS. 1-11 or the linking device housing 1203 of the electronic device 1200 of FIGS. 12-17.

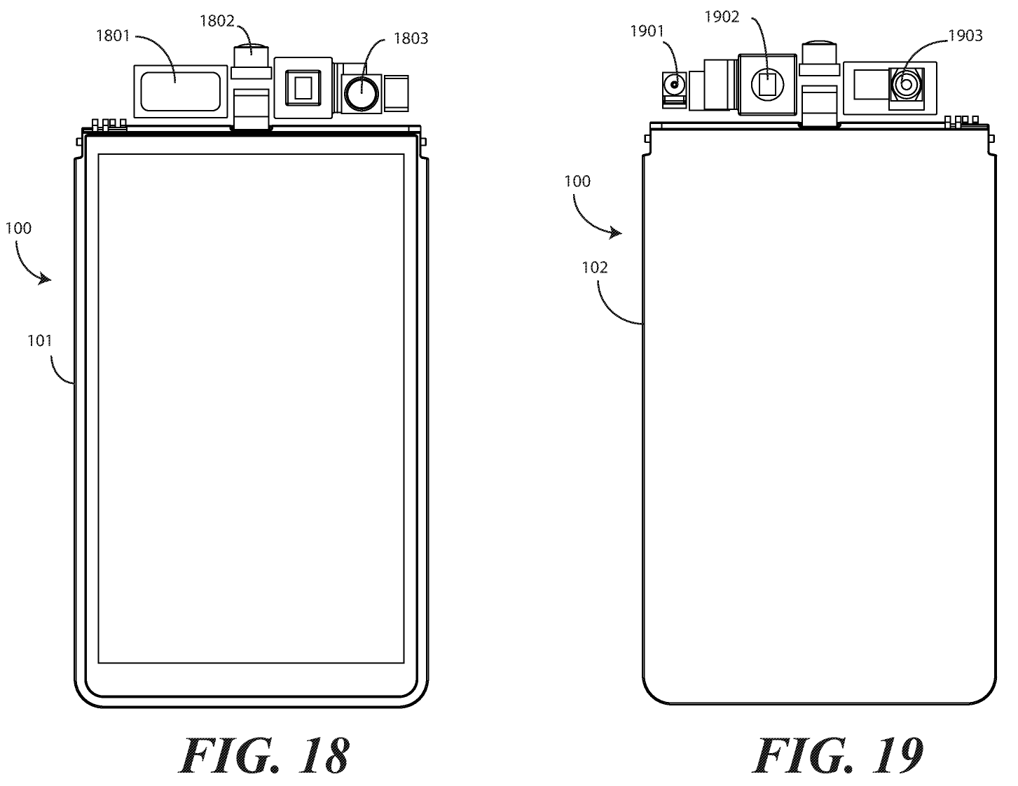

Turning now to FIGS. 18-20, illustrated therein is the electronic device 100 of FIGS. 1-11 with the linking device housing (103) removed. It is noted that the electronic device (1200) of FIGS. 12-17 can look the same in one embodiment, as the difference therebetween can be limited to the use of a single internal display or multiple internal displays in such an embodiment.

With the linking device housing removed (103), examples of large components that may be disposed within the linking device housing (103) can be seen. In this illustrative embodiment, the electronic device 100 includes a large loudspeaker 1801, a camera 1802 that faces upwardly out of an edge face of the linking device housing (103), and a fisheye camera 1803. The electronic device 100 also includes a structured light infrared emitter 1901, a high-resolution (twelve megapixel in one embodiment) imager 1902, and a structured infrared light detector 1903. Other devices could be included with, or instead of these components. Examples of such devices include audio input devices, e.g., microphones, biosensors, e.g., a temperature sensor or facial depth scanner, or infrared sensors.

These components, if added to either the first device housing 101 or the second device housing 102, would dramatically add thickness and would reduce the slim, compact, and lightweight form factor of the electronic device. However, the addition of the linking device housing (103) allows these larger components to be placed within the linking device housing (103) without adding thickness or bulk to either the first device housing 101 or the second device housing 102.

Thus, in one or more embodiments one or more sensors are disposed within the either the linking device housing 103 of the electronic device 100 or the linking device housing (1203) of the electronic device (1200) of FIGS. 12-17. As illustrated, these sensors can include audio output devices, audio input devices, imagers, biosensors, or infrared sensors. These are examples only, as other components particularly well suited for disposition within either the linking device housing (103) of the electronic device 100 or the linking device housing (1203) of the electronic device (1200) of FIGS. 12-17 will be obvious to those of ordinary skill in the art having the benefit of this disclosure.

Where devices such as camera 1802, fisheye camera 1803, structured light infrared emitter 1904, high-resolution imager 1902, and a structured infrared light detector 1903 are included, the linking device housing (103) can include one or more apertures that allow visible light or infrared light to pass through the sidewalls of the linking device housing (103) to these components. Examples of these apertures are shown in FIGS. 1-17 as circles placed at various locations along either the linking device housing (103) of the electronic device 100 or the linking device housing (1203) of the electronic device (1200) of FIGS. 12-17. More or fewer apertures can be included than those examples shown. Additionally, other locations for apertures will be obvious to those of ordinary skill in the art having the benefit of this disclosure. Any or all of the apertures can be covered with lenses, transparent coverings, mesh nets, grilles, or screens as well.

While the linking device housing (103) is shown removed from the electronic device 100 with the internal components remaining for illustration of what components can be included within the linking device housing (103), in one or more embodiments when the linking device housing (103) is removed the components therein are removed as well. This is true because in one or more embodiments the linking device housing (103) is modular. The components shown in FIGS. 18-20 can be incorporated into the linking device housing (103), which can attach to the first device housing 101 and/or second device housing 102 via electrical contacts when the linking device housing (103) mechanically attaches to the first device housing 101 and/or second device housing 102. This allows the linking device housing (103) to be detached from the two counter-rotatable housings so that another can be attached in its place. For example, a “projector” linking device housing that includes a light projector can be interchanged with a “music” linking device housing that includes high-powered stereo loudspeakers, and so forth. Other examples of modular linking device housings will be obvious to those of ordinary skill in the art having the benefit of this disclosure.

It is to be understood that FIGS. 18-20 Are provided for illustrative purposes only and for illustrating components of one electronic device 100 that can be incorporated into a linking device housing (103) in accordance with embodiments of the disclosure. As such, FIGS. 18-20 are not intended to be a complete schematic diagram of the various components required for an electronic device 100. Therefore, other electronic devices in accordance with embodiments of the disclosure may include various other components not shown in FIGS. 18-20, or may include a combination of two or more components or a division of a particular component into two or more separate components, and still be within the scope of the present disclosure.

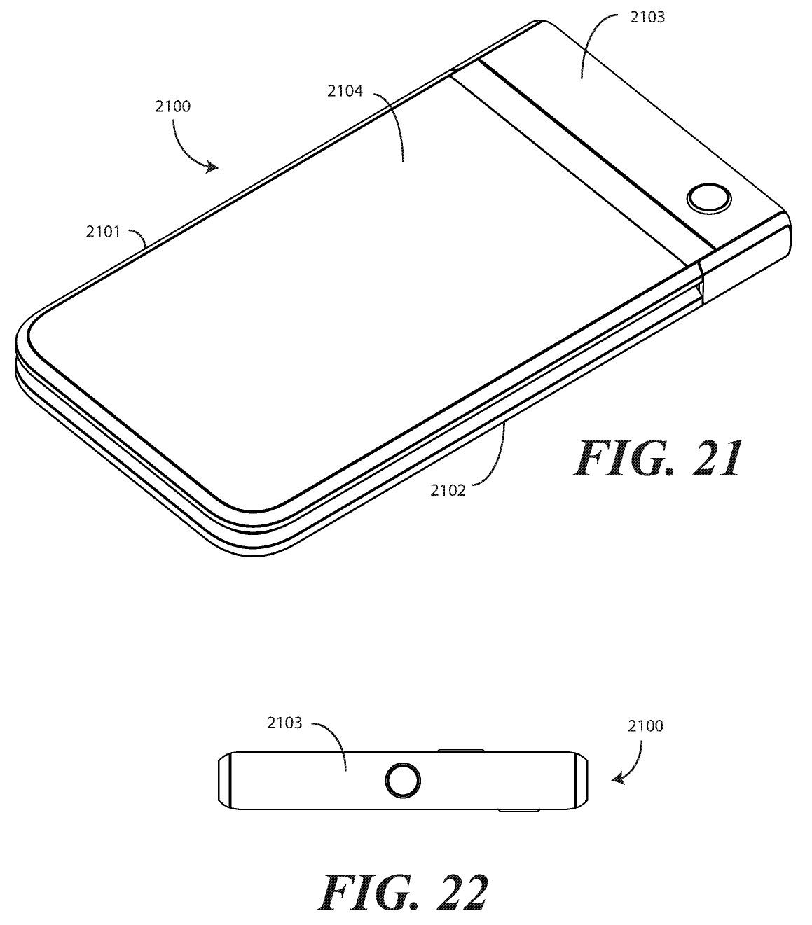

Turning now to FIGS. 21-32, illustrated therein is another explanatory electronic device 2100 configured in accordance with one or more embodiments of the disclosure. The electronic device 2100 of FIGS. 21-32 also includes a housing assembly. In one or more embodiments, the housing assembly comprises three different housing members: a first device housing 2101, a second device housing 2102, and a linking device housing 2103. In this illustrative embodiment, each of the first device housing 2101, the second device housing 2102, and the linking device housing 2103 have a common, coextensive width due to the fact that the width of the linking device housing 2103 is the same as the respective widths of each of the first device housing 2101 and the second device housing 2102.

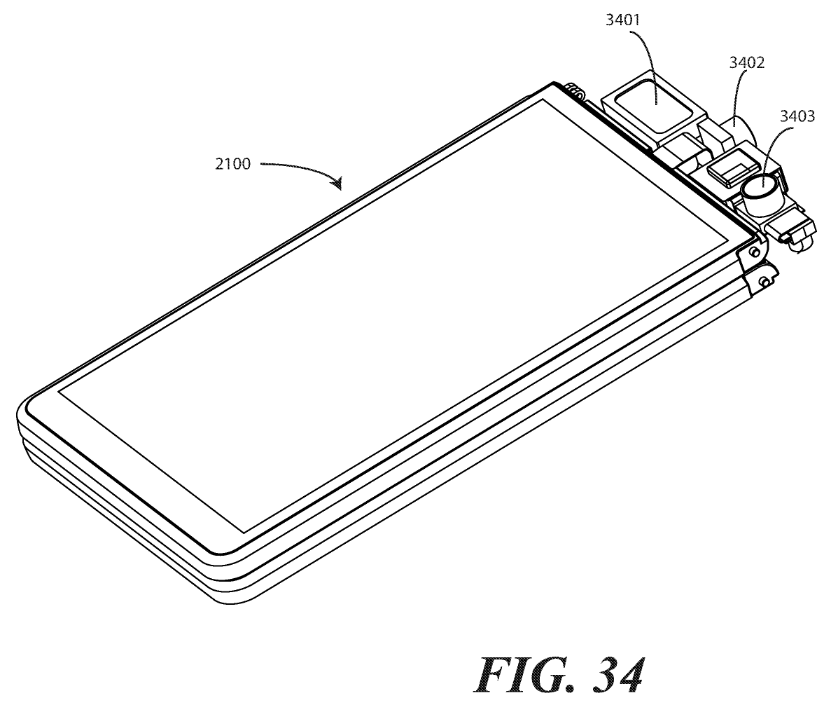

In this illustrative embodiment, the linking device housing 2103 is pivotally coupled between the first device housing 2101 and the second device housing 2102 by one or more hinges. In the illustrative embodiment of FIGS. 21-32, the electronic device includes a dual-axis hinge defined by a first hinge and a second hinge. The first hinge is defined by hinge fulcrums 2601,2602 and rotation pin (3404), which is shown in FIG. 34. The second hinge is defined by hinge fulcrums 2603,2604 and rotation pin (3405), also shown in FIG. 34. The dual-axis hinge facilitates a counter rotation of each of the first device housing 2101 and the second device housing 2102 relative to the linking device housing 2103 by about ninety-degrees when the first device housing 2101 and the second device housing 2102 pivot about the linking device housing 2103 from the closed position to the angularly displaced open position.

In one or more embodiments, each of rotation pin (3404) and rotation pin (3405) can define dual, parallel axes of rotation. Each of rotation pin (3404) and rotation pin (3405) can further serve as a mechanical axle about which the first device housing 2101 rotates relative to the linking device housing 2103, and the second device housing 2102 rotates relative to the linking device housing 2103, respectively. Thus, in one or more embodiments the electronic device 2100 includes a hinge, which in this illustration is a dual-axis hinge, which is disposed within the linking device housing 2103, and which pivotally coupling the two counter-rotatable device housings to the linking device housing 2103.

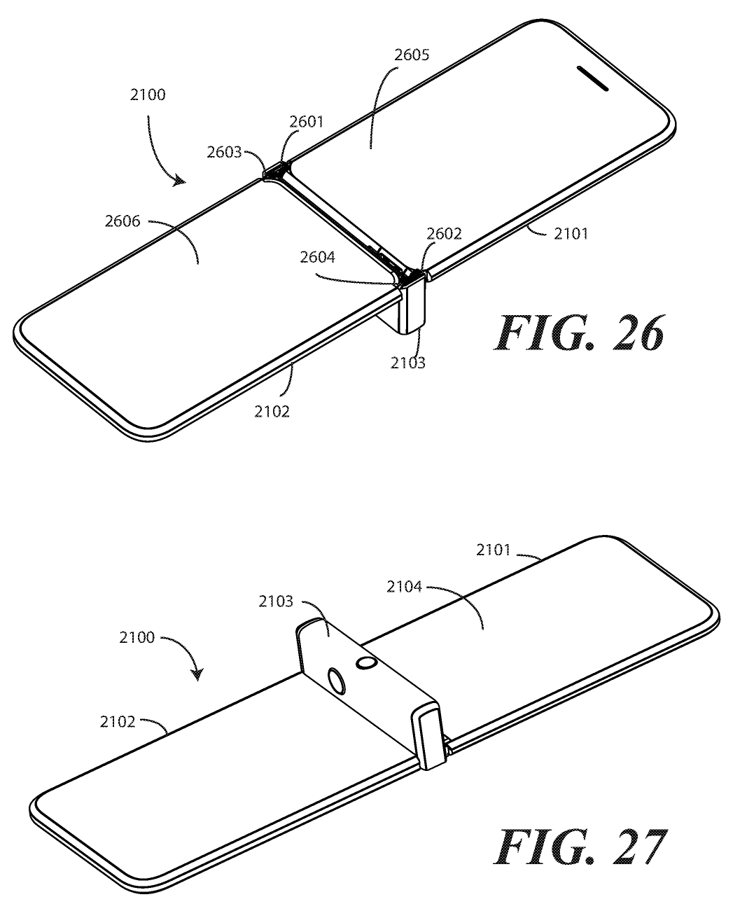

In one or more embodiments, the first device housing 2101 and the second device housing 2102 function as two counter-rotatable device housings. They are counter-rotatable because when transitioning from the closed position, shown in FIG. 21, to the open position, shown in FIG. 26, or from the open position to the closed position, they rotate in opposite directions. In one or more embodiments, each of the first device housing 2101, the second device housing 2102, and the linking device housing 2103 are manufactured from a rigid material such as a thin rigid, metal, although other materials can be used. Still other constructs will be obvious to those of ordinary skill in the art having the benefit of this disclosure.

As before, the linking device housing 2103 defines a planar surface extension of the first device housing 2101 and the second device housing 2102 when these two counter-rotatable device housings rotate about the linking device housing 2103 to the closed position where the two counter-rotatable device housings abut. In one or more embodiments, when the two counter-rotatable device housings defined by the first device housing 2101 and the second device housing 2102 rotate to the axially displaced open position shown in FIGS. 26-32, the linking device housing 2103 defines an orthogonal surface extension from the first device housing 2101 and the second device housing 2102. Said differently, when the first device housing 2101 and the second device housing 2102 pivot about the linking device housing 2103 from the closed position to the angularly displaced open position, the linking device housing 2103 extends substantially orthogonally from the first device housing 2101 and the second device housing 2102.

In one or more embodiments, a single, flexible, internal display is coupled to the first device housing 2101 and the second device housing 2102. Where used, the single, flexible, internal display additionally spans the linking device housing 2103. However, in the illustrative embodiment of FIGS. 21-32, the internal display can be replaced by two displays.

Instead of including a singular, internal display that is coupled to the first device housing 2101 and the second device housing 2102, thereby spanning the linking device housing 2103, in this illustrative embodiment two displays 2605,2606 are include on the interior of the electronic device 2100. The use of two displays 2605,2606, instead of a single flexible display, allows for each of the displays 2605,2606 to be fabricated on rigid substrates. Since the displays 2605,2606 do not have to bend, manufacturing and other costs are reduced.

In this illustrative embodiment, a first display 2605 is coupled to a first major face of the first device housing 2101, while a second display 2606 is coupled to a first major face of the second device housing 2102. One or both of the first display 2605 and the second display 2606 may optionally be touch-sensitive. In one embodiment, one or both of the first display 2605 and the second display 2606 is configured as an organic light emitting diode (OLED) display fabricated on a rigid or semi-rigid plastic substrate. However, it should be noted that other types of displays would be obvious to those of ordinary skill in the art having the benefit of this disclosure.

In this illustrative embodiment, the first device housing 2101 also includes a third display 2104. In this illustrative embodiment, the first display 2605 is coupled to the first major face of the first device housing 2101, while the third display 2104 is coupled to a second major face of the first device housing 2101. In this embodiment, the first major face is the interior major face, just as the first major face of the second device housing 2102 is an interior major face, while the second major face of the first device housing 2101 is an exterior major face.

As with the second display (108) of the embodiment of FIGS. 1-11, the third display 2104 can be a fully functional, high-resolution display in one embodiment. In other embodiments, the third display 2104 can present more basic information such as notifications of incoming messages, caller identification, time of day, weather information, and so forth without opening the electronic device 2100. As with the two internal displays 2605,2606, the third display 2104 can be touch sensitive. In one embodiment, the third display 2104 is configured as an organic light emitting diode (OLED) display fabricated on a substrate. In other embodiments, however, the third display 2014 can be a lower resolution or can consume less power than the two internal displays 2605,2606. In some embodiments, the two internal displays 2605,2606 can be high-resolution displays, while the third display 2104 has lower resolution or consumes less power, as previously described. In still other embodiments, the third display 2014 can be an electrophoretic display, “e-ink” display, or other display that consumes to little to no power when the electronic device 2100 is closed.

In one or more embodiments, an indent feature, which can be defined by a recess or indent 2501 about the perimeter of one of the first device housing 2101 or the second device housing 2102 can be added to assist in opening the electronic device 2100. In FIG. 25, indent 2501 in the second device housing 102 provides a recess into which a user could insert the tip of a finger or a finger nail to make contact with, and apply pressure to, the first device housing 2101 to initiate the rotation from the closed position where the first device housing 2101 and the second device housing 2102 abut to the open position where the first device housing 2101 and the second device housing 2102 are substantially coplanar. The inclusion of an indent 2501, which is optional, effectively can make it easier for a user to start the first device housing 2101 and the second device housing 2102 pivoting about the linking device housing 2103 from the closed position to the open position where the first device housing 2101 and the second device housing 2102 are substantially coplanar.

As shown by comparing FIGS. 21-15 and 26-32, the first device housing 2101 and the second device housing 2102 rotate radially by about 180-degrees when transitioning from the closed position where the first device housing 2101 and the second device housing 2102 abut to the open position where the first device housing 2101 and the second device housing 2102 are substantially coplanar. At the same time, the linking device housing 2103 rotates only about 90-degrees from the upper part of the closed electronic device to the middle, and rear, of the open electronic device.

Accordingly, when the first device housing 2101 and the second device housing 2102 pivot about the linking device housing 2103 from the closed position to the open position where the first device housing 2101 and the second device housing 2102 are substantially coplanar, the electronic device 2100 defines a “T” shape, with the linking device housing 2103 defining the base of the T-shape, and the first device housing 2101 and the second device housing 2102, which are substantially coplanar in the open position, define the top, horizontal member of the T-shape. This construct that includes two counter-rotatable device housings pivotally attached to the linking device housing 2103 offers numerous advantages over prior art designs. By defining the T-shape, the electronic device 2100 in the open position offers numerous advantageous ways to hold the electronic device 2100 in the hand, as previously described.

Features can be incorporated into the first device housing 2101 and/or the second device housing 2102. Examples of such features include an optional camera or an optional speaker port. A user interface component, which may be a button or touch sensitive surface, can also be disposed along the first device housing 2101 or the second device housing 2102. Small components, such as thin loudspeakers and thin microphones, can be placed in the first device housing 2101 and the second device housing 2102, along with one or more displays, while maintaining a very thin and light form factor.

In one or more embodiments, an energy storage device, such as a rechargeable lithium-ion, lithium-polymer, or other type of battery, can be disposed within the first device housing 2101. In one or more embodiments, this causes the center of gravity of the overall electronic device 2100 to move to the side of the linking device housing 2103 containing the energy storage device. In this “bottom weighted” design, a user can more readily see the interior displays 2605,2606 when the electronic device 2100 is placed on a flat surface. As best shown in FIG. 26, this causes the first device housing 2101 to “tip” downward, with the linking device housing 2103 serving as a fulcrum. When the user is situated on the first device housing side, this makes the electronic device 2100 toward the user, thereby making the interior displays 2605,2606 easier for the user to see. Accordingly, in one or more embodiments, the first device housing 2101 and a center of gravity of the electronic device 2100 are on a common side of the linking device housing 2103 when the two counter-rotatable device housings rotate to the axially displaced open position.

As before, larger components, such as high-resolution imagers, can be placed within either the linking device housing 2103 of the electronic device 2100. Similarly, other large component such as high-powered loudspeakers, directional microphone arrays requiring multiple microphones at orthogonal vectors and separated a certain distance apart, infrared, flood, and structured light sensor components, certain biometric sensors, and other large components can be placed in the either the linking device housing 2103 of the electronic device 2100.

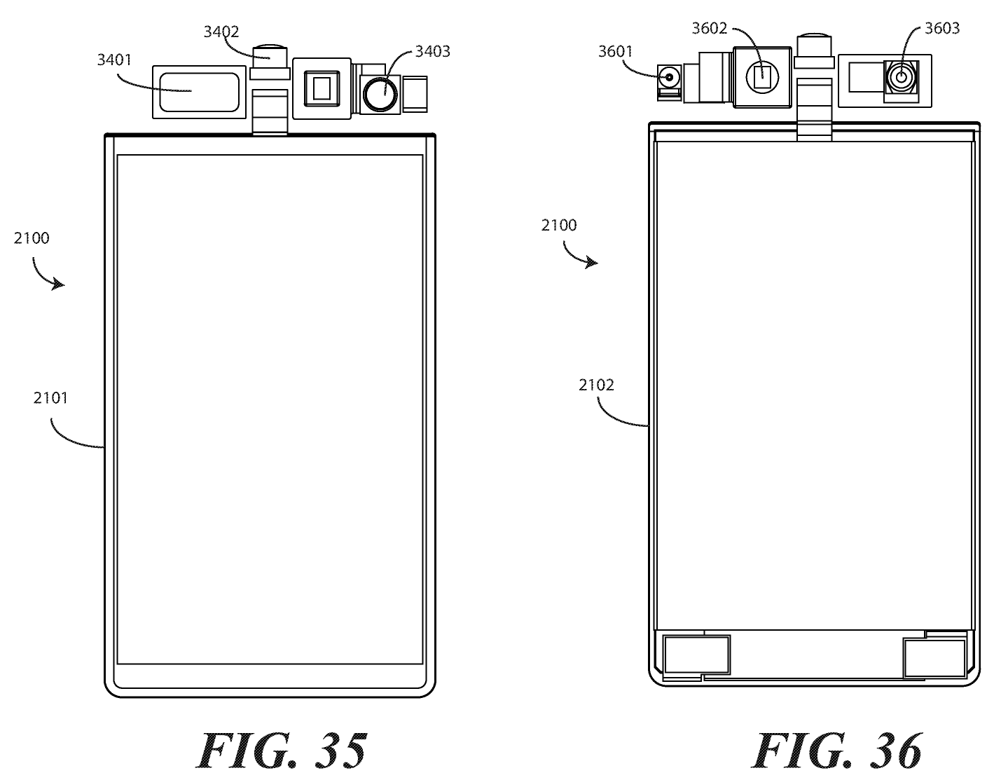

Turning now to FIGS. 34-36, illustrated therein is the electronic device 2100 of FIGS. 21-32 with the linking device housing (2103) removed. With the linking device housing (2103) removed, examples of large components that may be disposed within the linking device housing (2103) can be seen. In this illustrative embodiment, the electronic device 2100 includes a large loudspeaker 3401, a camera 3402 that faces upwardly out of an edge face of the linking device housing (2103), and a fisheye camera 3403. The electronic device 2100 also includes a structured light infrared emitter 3601, a high-resolution (twelve megapixel in one embodiment) imager 3602, and a structured infrared light detector 3603. Other devices could be included with, or instead of these components. Examples of such devices include audio input devices, e.g., microphones, biosensors, e.g., a temperature sensor or facial depth scanner, or infrared sensors. These are examples only, as other components particularly well suited for disposition within either the linking device housing (2103) of the electronic device 2100 will be obvious to those of ordinary skill in the art having the benefit of this disclosure.

As before, in one or more embodiments when the linking device housing (2103) is removed the components therein are removed as well. This is true because in one or more embodiments the linking device housing (2103) is modular. The components shown in FIGS. 34-36 can be incorporated into the linking device housing (1203), which can attach to the first device housing 2101 and/or second device housing 2102 via electrical contacts when the linking device housing (2103) mechanically attaches to the first device housing 2101 and/or second device housing 2102. This allows the linking device housing (2103) to be detached from the two counter-rotatable housings so that another can be attached in its place. For example, a “projector” linking device housing that includes a light projector can be interchanged with a “music” linking device housing that includes high-powered stereo loudspeakers, and so forth. Other examples of modular linking device housings will be obvious to those of ordinary skill in the art having the benefit of this disclosure.

In addition to being placed in the closed position or the open position, the pivotal coupling of the first device housing 2101 and the second device housing 2102 to the linking device housing (2103) allows the electronic device 2100 to be manipulated into other geometries as well. Turning now to FIG. 33, illustrated therein is one such geometry.

In the illustrative embodiment of FIG. 33, the electronic device 2100 has been placed on a table or other flat surface, with a user's bending operation leaving the electronic device 2100 to resemble a card folded into a “tent fold.” This bent configuration can make the third display 2104 easier for a user to view since they do not have to hold the electronic device 2100 in their hands.

In one or more embodiments, the operational mode of the electronic device 2100 can change as a function of its geometry. Illustrating by example, the electronic device 2100 might function as a palm-top computer when in the open position. By contrast, when in the bent configuration of FIG. 33, the electronic device 2100 may function as an alarm clock, as the electronic device 2100 easily rests on a flat surface. When in the closed position, the electronic device 2100 may function as a smartphone or other device. These functions are illustrative only, as the geometry-based predefined mode of operation could also be any number of other modes, as will be obvious to those of ordinary skill in the art having the benefit of this disclosure.

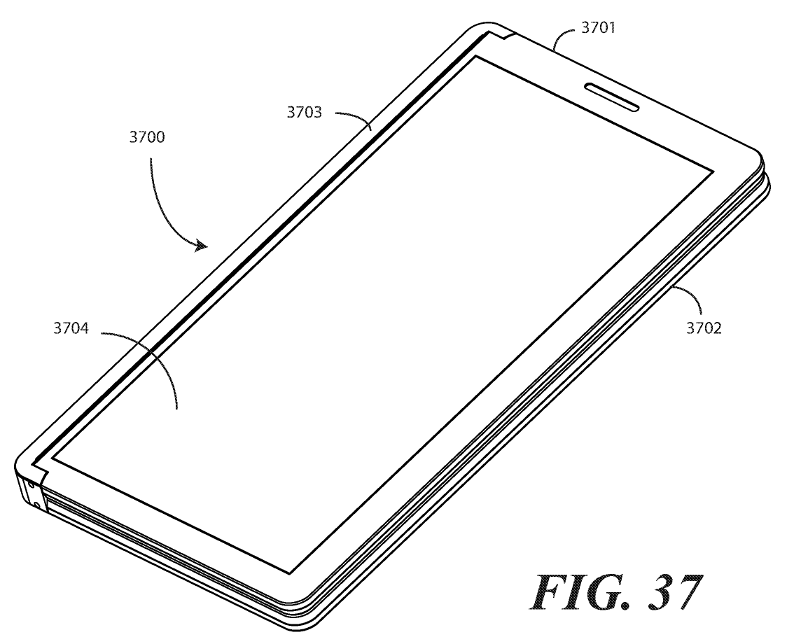

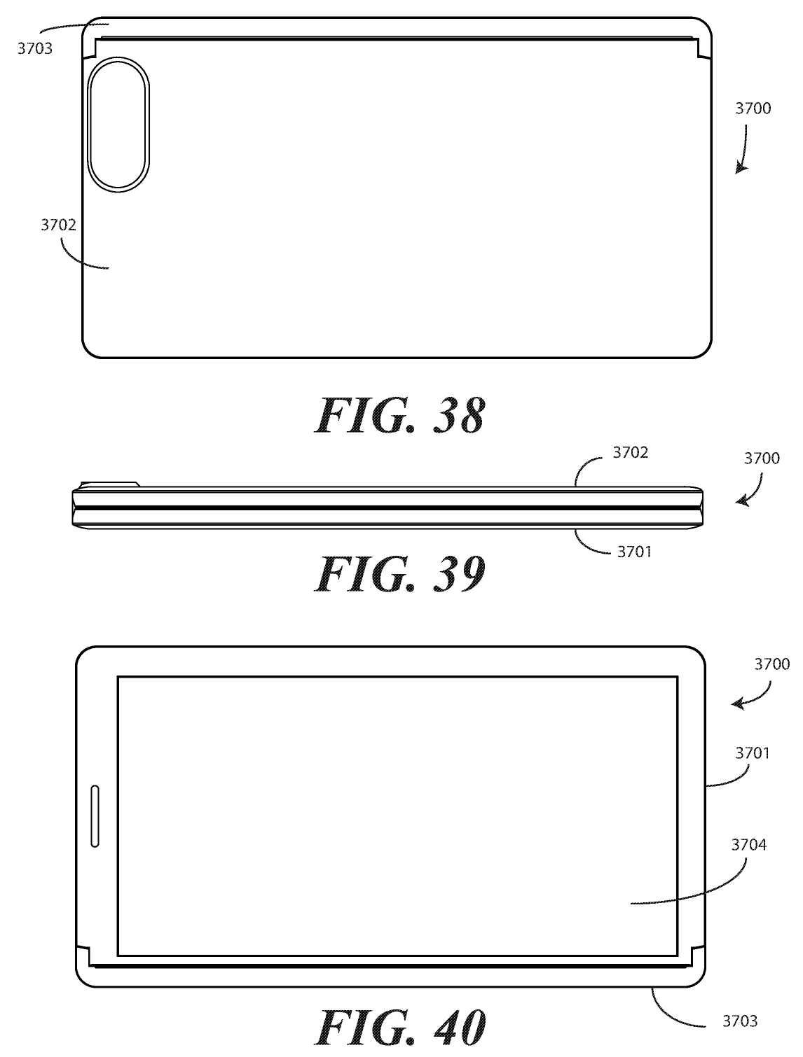

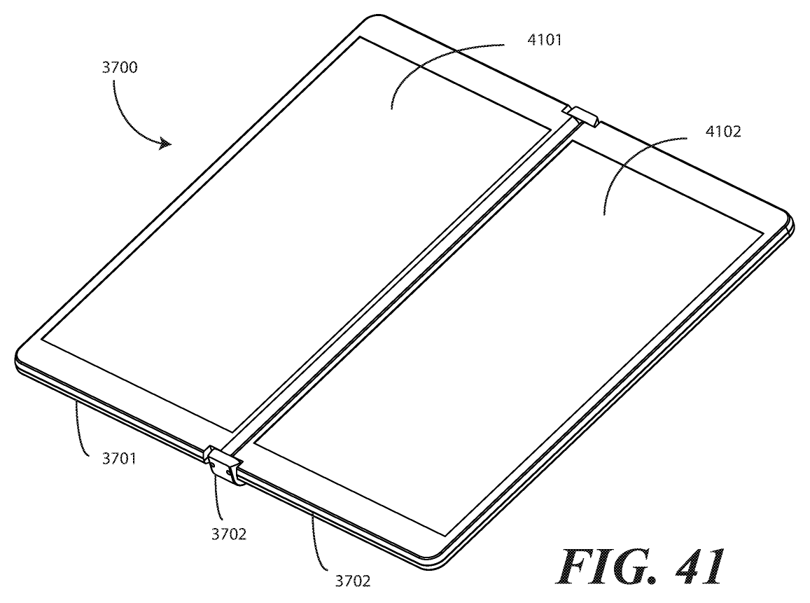

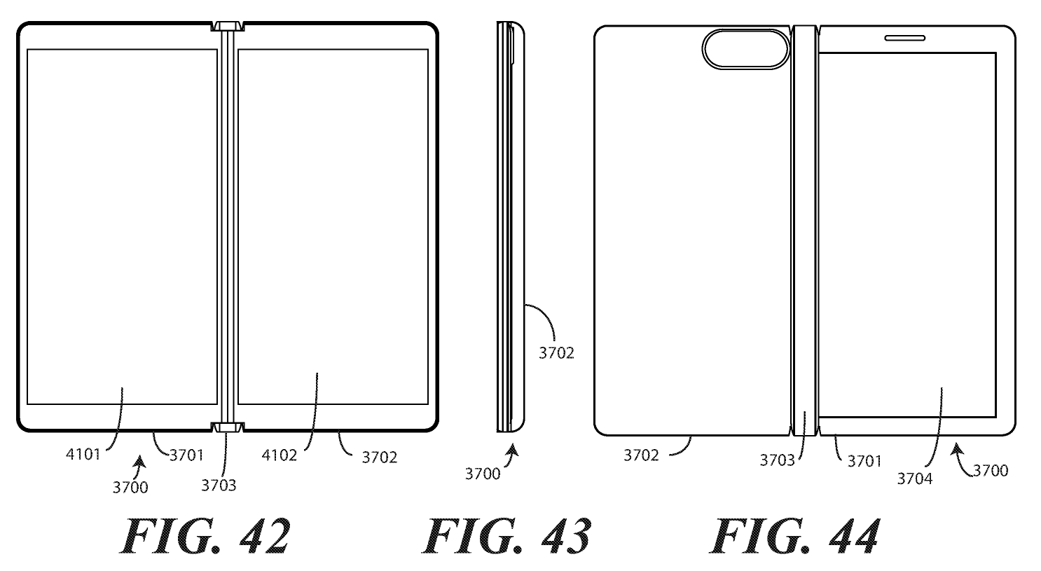

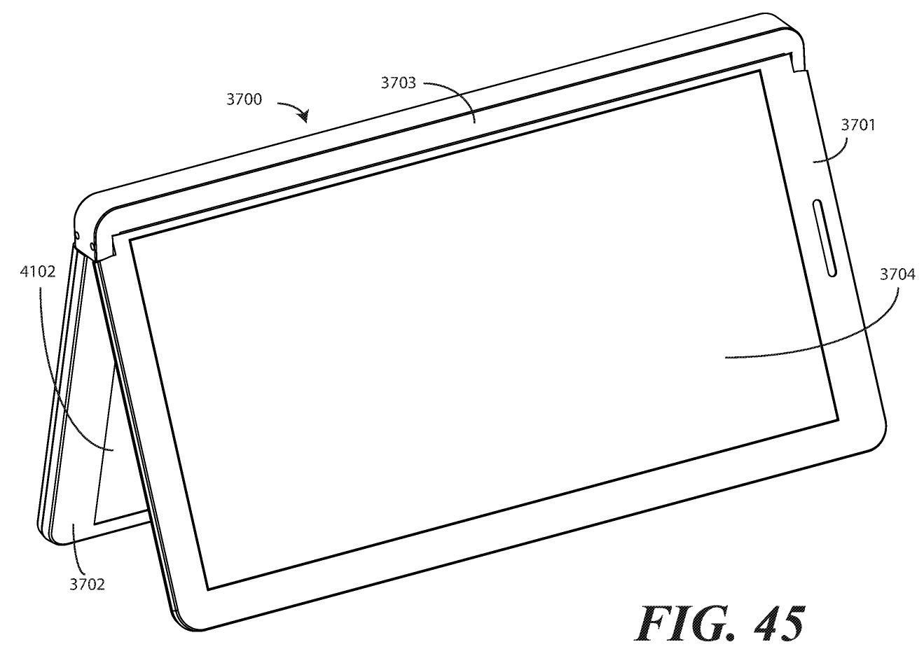

Turning now to FIGS. 37-45, illustrated therein is yet another electronic device 3700 configured in accordance with one or more embodiments of the disclosure. The electronic device 3700 of FIGS. 37-45 includes many of the features of the electronic devices previously described. Illustrating by example, the electronic device 3700 of FIGS. 37-45 include a linking device housing 3703 between a first device housing 4701 and a second device housing 3702 allows the electronic device 3700 to be bent or folded. As before, the linking device housing 3703 is pivotally coupled between the first device housing 3701 and the second device housing 3702 by one or more hinges. In this embodiment, the hinge is a dual-axis hinge, which is disposed within the linking device housing 3703, and which pivotally coupling the two counter-rotatable device housings to the linking device housing 3703.

In the embodiment of FIGS. 37-45, the linking device housing 3703 is disposed along a side having a major dimension of the electronic device 3700. This is in contrast to the embodiments of FIGS. 1-36, in which linking device housings were disposed along a side having a minor dimension of those electronic devices. Said differently, the linking device housing 3703 of the electronic device 3700 of FIGS. 37-45 is disposed along a side edge having a dimension longer than another, adjacent, side edge of the electronic device 3700. The linking device housing 3703 runs the length of the electronic device 3700, rather than the width of the electronic device 3700, which is a shorter dimension than the length.

When transitioning from the closed position to the open position, the first device housing 3701 rotates in a first direction relative to the linking device housing 3703, while the second device housing 3702 rotates in a second direction 3705 relative to the linking device housing 3703. When transitioning from the open position to the closed position, the first device housing v01 rotates in a direction opposite the first direction relative to the linking device housing 3703, while the second device housing 3702 rotates in a direction opposite the second direction relative to the linking device housing v03.

As before, the linking device housing 3703 defines a planar surface extension of the first device housing 3701 and the second device housing 3702 when these two counter-rotatable device housings rotate about the linking device housing 3703 to the closed position where the two counter-rotatable device housings abut. In one or more embodiments, when the first device housing 3701 and the second device housing 3702 rotate to the axially displaced open position shown in FIGS. 37-45, the linking device housing 3703 defines an orthogonal surface extension from the first device housing 3701 and the second device housing 3702. Said differently, when the first device housing 3701 and the second device housing 3702 pivot about the linking device housing 3703 from the closed position to the angularly displaced open position, the linking device housing 3703 extends substantially orthogonally from the first device housing 3701 and the second device housing 3702.

Instead of including a singular, internal display that is coupled to the first device housing 3701 and the second device housing 3702, thereby spanning the linking device housing 3703, in this illustrative embodiment two displays 4101,4102 are include on the interior of the electronic device 3700. The use of two displays 4101,4102, instead of a single flexible display, allows for each of the displays 4101,4102 to be fabricated on rigid substrates. Since the displays 4101,4102 do not have to bend, manufacturing and other costs are reduced.

In this illustrative embodiment, a first display 4101 is coupled to a first major face of the first device housing 3701, while a second display 4102 is coupled to a first major face of the second device housing 3702. One or both of the first display 4101 and the second display 4102 may optionally be touch-sensitive. In one embodiment, one or both of the first display 4101 and the second display 4102 is configured as an organic light emitting diode (OLED) display fabricated on a rigid or semi-rigid plastic substrate. However, it should be noted that other types of displays would be obvious to those of ordinary skill in the art having the benefit of this disclosure.

In this illustrative embodiment, the first device housing 3701 also includes a third display 3704. In this illustrative embodiment, the first display 4101 is coupled to the first major face of the first device housing 3701, while the third display 3704 is coupled to a second major face of the first device housing 3701. In this embodiment, the first major face is the interior major face, just as the first major face of the second device housing 3702 is an interior major face, while the second major face of the first device housing 3701 is an exterior major face.

As with the second display (108) of the embodiment of FIGS. 1-11, the third display 3704 can be a fully functional, high-resolution display in one embodiment. In other embodiments, the third display 3704 can present more basic information such as notifications of incoming messages, caller identification, time of day, weather information, and so forth without opening the electronic device 3700. As with the two internal displays 4101,4102 the third display 3704 can be touch sensitive. In one embodiment, the third display 3704 is configured as an organic light emitting diode (OLED) display fabricated on a substrate. In other embodiments, however, the third display 3704 can be a lower resolution or can consume less power than the two internal displays 4101,4102. In some embodiments, the two internal displays 4101,4102 can be high-resolution displays, while the third display 3704 has lower resolution or consumes less power, as previously described. In still other embodiments, the third display 3704 can be an electrophoretic display, “e-ink” display, or other display that consumes to little to no power when the electronic device 3700 is closed.

Features can be incorporated into the first device housing 3701 and/or the second device housing 3702. Examples of such features include an optional camera or an optional speaker port. A user interface component, which may be a button or touch sensitive surface, can also be disposed along the first device housing 3701 or the second device housing 3702. Small components, such as thin loudspeakers and thin microphones, can be placed in the first device housing 3701 and the second device housing 3702, along with an energy storage device and/or one or more displays, while maintaining a very thin and light form factor.

In one or more embodiments, the first device housing 3701 and the second device housing 3702 rotate radially by 180-degrees when transitioning from the closed position where the first device housing 3701 and the second device housing 3702 abut to the open position where the first device housing 3701 and the second device housing 3702 are substantially coplanar. At the same time, the linking device housing 3703 rotates only about 90-degrees from the upper part of the closed electronic device to the middle, and rear, of the open electronic device. Accordingly, when the first device housing 3701 and the second device housing 3702 pivot about the linking device housing 3703 from the closed position to the open position where the first device housing 3701 and the second device housing 3702 are substantially coplanar, the electronic device 3700 defines a “T” shape, with the linking device housing 3703 defining the base of the T-shape, and the first device housing 3701 and the second device housing 3702, which are substantially coplanar in the open position, define the top, horizontal member of the T-shape. The electronic device 3700 can also be semi-folded to the tent configuration of FIG. 45 in one or more embodiments.

Larger components, such as high-resolution imagers, can be placed within either the linking device housing 3703 of the electronic device 3700. Similarly, other large components such as high-powered loudspeakers, directional microphone arrays requiring multiple microphones at orthogonal vectors and separated a certain distance apart, infrared, flood, and structured light sensor components, certain biometric sensors, and other large components can be placed in the either the linking device housing 3703 of the electronic device 3700 as previously described.

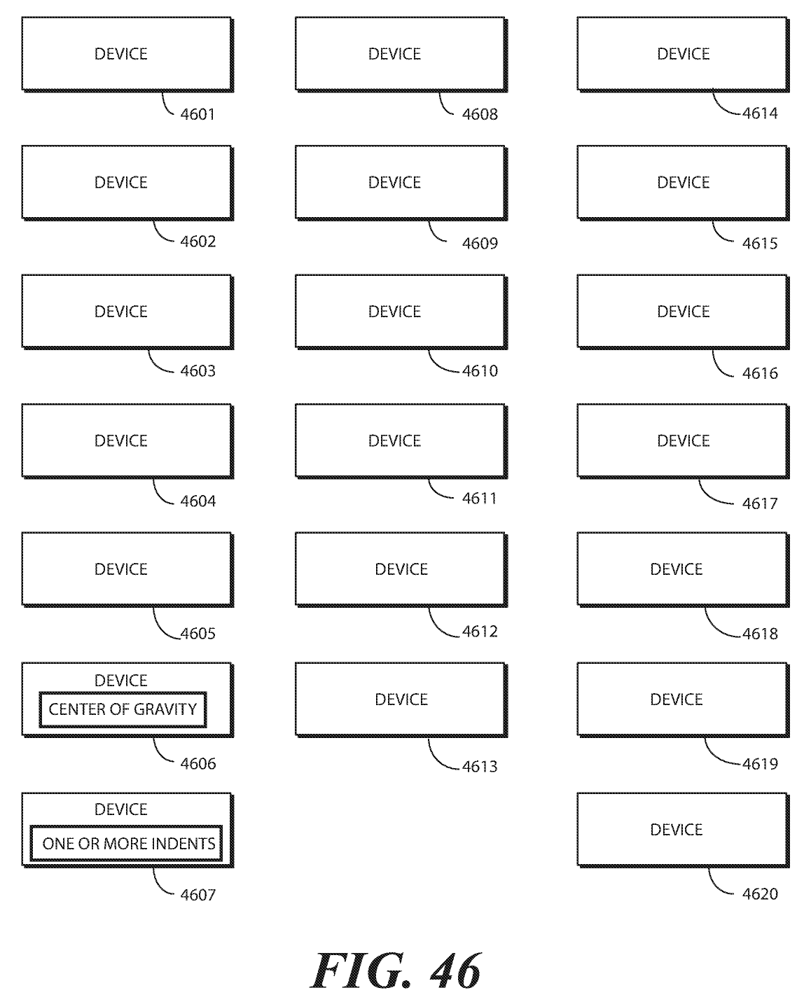

Turning now to FIG. 46, illustrated therein are various embodiments of the disclosure. At 4601, an electronic device comprises a linking housing pivotally coupled between two counter-rotatable device housings. At 4601, the linking housing defines a planar surface extension of the two counter-rotatable device housings when the two counter-rotatable device housings rotate about the linking housing to a closed position where the two counter-rotatable device housings abut. At 4601, the linking housing defines an orthogonal surface extension from the two counter-rotatable device housings when the two counter-rotatable device housings rotate to an axially displaced open position.

At 4602, the electronic device further comprises a flexible display coupled to the two counter-rotatable device housings and spanning the linking housing. At 4603, the two counter-rotatable device housings of 4601 comprise a first device housing and a second device housing.

At 4604, the electronic device of 4603 further comprises a first display coupled to the first device housing, a second display coupled to a first major face of the second device housing, and a third display coupled to a second major face of the second device housing. At 4605, the electronic device of 4603 further comprise an energy storage device disposed within the first device housing. At 4606, the first device housing and a center of gravity of 4603 are on a common side of the linking housing when the two counter-rotatable device housings rotate to the axially displaced open position.

At 4607, the first device housing of 4603 comprises one or more indents about a perimeter of the first device housing through which contact with the second device housing can occur. At 4608, the electronic device of 4601 further comprises a hinge disposed within the linking housing. At 4608, the hinge pivotally couples the two counter-rotatable device housings to the linking housing.

At 4609, the hinge of 4608 comprises a single-axis hinge. At 4610, the hinge of 4608 comprises a dual-axis hinge. At 4611, the dual-axis hinge of 4610 comprises a first rotation pin coupled between a first pair of hinge fulcrums and a second rotation pin coupled between a second pair of hinge fulcrums.

At 4612, the electronic device of 4601 further comprises one or more sensors disposed within the linking housing. At 4613, the one or more sensors of 4612 comprise one or more of an audio output device, an audio input device, an imager, a biosensor, or an infrared sensor. At 4614, the two counter-rotatable device housings of 4601 and the linking housing have a common, coextensive width.

At 4615, an electronic device comprises a first device housing comprising a first device housing exterior surface. At 4615, the electronic house comprises a second device housing comprising a second device housing exterior surface. At 4615, the electronic device comprises a linking device housing hingedly coupled between the first device housing and the second device housing.

At 4615, the linking device housing defines an extension of each of the first device housing exterior surface and the second device housing exterior surface when the first device housing and the second device housing pivot about the linking device housing to a closed position. At 4615, the linking device housing extends substantially orthogonally from the first device housing and the second device housing when the first device housing and the second device housing pivot about the linking device housing from the closed position to an angularly displaced open position.

At 4616, the electronic device of 4615 further comprises a hinge disposed within the linking device housing. At 4616, the hinge facilitates a counter rotation of each of the first device housing and the second device housing relative to the linking device housing by about ninety-degrees when the first device housing and the second device housing pivot about the linking device housing from the closed position to the angularly displaced open position.

At 4617, the electronic device of 4615 further comprises a first display coupled to a first major face of the first device housing and a second display coupled to a second major face of the first device housing. At 4618, the first display of 4617 is further coupled to the second device housing and spans the linking device housing.

At 4619, an electronic device comprises a first device housing comprising a first device housing exterior surface. At 4619, the electronic device comprises a second device housing comprising a second device housing exterior surface. At 4619, the electronic device comprises a linking device housing hingedly coupled between the first device housing and the second device housing, the linking device housing comprising a first major face and a second major face.

At 4619, the first major face is substantially coplanar with the first device housing exterior surface when the first device housing and the second device housing pivot about the linking device housing to a closed position where the first device housing and the second device housing abut. At 4619, the first major face is substantially perpendicular with the first device housing exterior surface when the first device housing and the second device housing pivot about the linking device housing from the closed position to an open position where the first device housing and the second device housing are substantially coplanar. At 4620, the electronic device of 4619 further comprises an imager disposed within the linking device housing.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

1. An electronic device, comprising:
a linking housing pivotally coupled between two counter-rotatable device housings;
the linking housing defining a planar surface extension of the two counter-rotatable device housings when the two counter-rotatable device housings rotate about the linking housing to a closed position where the two counter-rotatable device housings abut; and
the linking housing defining an orthogonal surface extension from the two counter-rotatable device housings when the two counter-rotatable device housings rotate to an axially displaced open position;
further comprising one or more sensors disposed within the linking housing.

2. (canceled)

3. The electronic device of claim 1, the two counter-rotatable device housings comprising a first device housing and a second device housing.

4. The electronic device of claim 3, further comprising a first display coupled to the first device housing, a second display coupled to a first major face of the second device housing, and a third display coupled to a second major face of the second device housing.

5. The electronic device of claim 3, further comprising a first display coupled to the first device housing, a physical keypad coupled to a first major face of the second device housing, and a third display coupled to a second major face of the second device housing.

6. The electronic device of claim 3, wherein the first device housing and a center of gravity of the electronic device are on a common side of the linking housing when the two counter-rotatable device housings rotate to the axially displaced open position.

7. The electronic device of claim 3, the first device housing comprising one or more indents about a perimeter of the first device housing through which contact with the second device housing can occur.

8. The electronic device of claim 1, further comprising a hinge disposed within the linking housing, the hinge pivotally coupling the two counter-rotatable device housings to the linking housing.

9. The electronic device of claim 8, wherein the hinge comprises a single-axis hinge.

10. (canceled)

11. (canceled)

12. The electronic device of claim 1, the one or more sensors disposed within the linking housing comprising one or more of a loudspeaker or an imager.

13. (canceled)

14. The electronic device of claim 1, wherein the two counter-rotatable device housings and the linking housing have a common, coextensive width.

15. An electronic device, comprising:
a first device housing comprising a first device housing exterior surface;
a second device housing comprising a second device housing exterior surface; and
a linking device housing hingedly coupled between the first device housing and the second device housing;
the linking device housing defining an extension of each of the first device housing exterior surface and the second device housing exterior surface when the first device housing and the second device housing pivot about the linking device housing to a closed position; and
the linking device housing extending from the first device housing and the second device housing when the first device housing and the second device housing pivot about the linking device housing from the closed position to an angularly displaced open position;
wherein the first device housing and a center of gravity of the electronic device are on a common side of the linking housing when the two counter-rotatable device housings rotate to the axially displaced open position.

16. The electronic device of claim 15, further comprising a hinge disposed within the linking device housing, the hinge facilitating a counter rotation of each of the first device housing and the second device housing relative to the linking device housing by about ninety-degrees when the first device housing and the second device housing pivot about the linking device housing from the closed position to the angularly displaced open position.

17. The electronic device of claim 15, further comprising a first display coupled to a first major face of the first device housing and a second display coupled to a second major face of the first device housing.

18. (canceled)

19. An electronic device, comprising:
a first device housing comprising a first device housing exterior surface;
a second device housing comprising a second device housing exterior surface; and
a linking device housing hingedly coupled between the first device housing and the second device housing, the linking device housing comprising a first major face and a second major face, and defining one or more apertures that allow visible light or infrared light to pass through the sidewalls of the linking device housing;
wherein the first major face is substantially coplanar with the first device housing exterior surface when the first device housing and the second device housing pivot about the linking device housing to a closed position where the first device housing and the second device housing abut; and
wherein the first major face is substantially perpendicular with the first device housing exterior surface when the first device housing and the second device housing pivot about the linking device housing from the closed position to an open position where the first device housing and the second device housing are substantially coplanar.

20. (canceled)
